(19) United States
(12) Patent Application Publication
(10) Pub. No.: US 2007/0121550 A1
(43) Pub. Date: May 31, 2007

(54) Wireless apparatus, monitor camera system using the wireless apparatus, and audio-video listening and viewing system using the wireless apparatus

(76) Inventor: Keiichiro Wada, Kyoto (JP)

Correspondence Address: MCDERMOTT WILL & EMERY LLP, 600 13TH STREET, N.W., WASHINGTON, DC, 20005-3096, US

(21) Appl. No.: 11/507,638

(22) Filed: Aug. 22, 2006

(30) Foreign Application Priority Data
Nov. 25, 2005 (JP) 2005-340236

(51) Int. Cl. H04Q 7/00

(52) U.S. Cl. 370/332

(57) ABSTRACT

A wireless apparatus has a wireless reception unit for receiving a wireless signal, extracting a reception beacon signal and a reception frame body signal from the wireless signal, and outputting the extracted reception beacon signal and the extracted reception frame body signal, a frame body disassembly unit for receiving the reception frame body signal, extracting a reception time stamp and a packet from the reception frame body signal, and outputting the extracted reception time stamp and the extracted packet, a packet read control unit for generating a packet read signal for controlling the outputting of the packet based on the reception time stamp and outputting the packet read signal, and a wireless reference clock generation unit for generating a wireless clock and outputting the wireless clock to the frame body disassembly unit and to the packet read control unit. The wireless reference clock generation unit selects either one of a free-running master clock and a clock which is synchronized with the reception beacon signal and outputs the selected one as the wireless clock.

### CROSS-REFERENCE TO RELATED APPLICATIONS

The teachings of Japanese Patent Application JP 2005-340236, filed Nov. 25, 2005, are entirely incorporated herein by reference, inclusive of the claims, specification, and drawings.

### BACKGROUND OF THE INVENTION

The present invention relates to a wireless apparatus for wirelessly transmitting data which requires a real-time bandwidth guarantee, such as audio data or video data.

In recent years, equipment using a wireless LAN (Local Area Network) in place of a wired LAN has become widespread. In addition, the increased transmission speed of a wireless LAN has made it possible to employ an apparatus using the wireless LAN as means for performing high-quality and high-speed transmission of video data or the like.

A description will be given herein below to a wireless apparatus according to a conventional embodiment.

FIG. 17 shows a conventional wireless apparatus 101. The wireless apparatus 101 has a transmission functional portion 101a and a reception functional portion 101b, which respectively perform a transmission process and a reception process each by using an antenna 102. The transmission functional portion 101a comprises: a time stamp add unit 106; a frame body assembly unit 105; and a wireless transmission unit 103. The reception functional portion 101b comprises: a wireless reception unit 104; a digital filter 107; a frame body disassembly unit 109; and a packet read control unit 110. In addition, the wireless apparatus 101 also comprises a wireless clock 111.

Each of the wireless transmission unit 103 and the wireless reception unit 104 comprises an RF (Radio Frequency), a baseband, each of which is a physical layer, and a layer-2 processor for processing a data link layer, though they are not depicted.

A description will be given herein below to the operation of the wireless apparatus having a structure as described above. It will be easily understood that, when a wireless signal 117 is wirelessly transmitted, a plurality of wireless apparatus are used. FIG. 17 illustrates the transmission of the wireless signal 117 between the wireless apparatus 101 and another wireless apparatus 101x. It may be considered that the other wireless apparatus 101x has the same structure as the wireless apparatus 101 herein. In the following description, however, transmitting and receiving operations will be shown collectively using only the wireless apparatus 101 for simplified illustration. Specifically, the operation of transmitting the wireless signal 117, which is performed by the transmission functional portion 101a of the wireless apparatus 101 via the antenna 102, will be described simultaneously with the operation of receiving the wireless signal 117 which is intrinsically performed by the other wireless apparatus 101x. However, instead of describing the receiving operation by showing the detailed structure of the other wireless apparatus 101x, the receiving operation will be described on the assumption that it is performed by the reception functional portion 101b of the wireless apparatus 101 via the antenna 102, not by the other wireless apparatus 101x.

A packet input 112 to the wireless apparatus is inputted first to the time stamp add unit 106. The time stamp add unit 106 generates a time-stamp-added packet 114 by adding a time stamp to the packet input 112 and outputs the time-stamp-added packet 114 to the frame body assembly unit 105. At this stage, a transmission beacon signal 115 is inputted from the wireless transmission unit 103 to the time stamp add unit 106 so that the time stamp is added in accordance with the input timing of the packet input 112 based on the transmission beacon signal 115. More specifically, the value of the transmission beacon signal 115 is held at the time at which the packet input 112 is inputted and the held value is added to the packet input 112.

The frame body assembly unit 105 generates a frame body signal 116 for a wireless LAN from a single time-stamp-added packet 114 or from an assembly of a plurality of time-stamp-added packets 114 and outputs the frame body signal 116 for wireless LAN to the wireless transmission unit 103. The wireless transmission unit 103 adds a header, which is needed in the wireless LAN, to the frame body signal 116, further modulates the frame body signal 116 with the header, and transmits the modulated frame body signal 116 as the wireless signal 117 via the antenna 102.

The wireless signal 117 is received by the other wireless apparatus 101x. However, the description will be given instead to the substitute case where the wireless apparatus 101 has received the wireless signal 117, as stated previously.

The wireless reception unit 104 that has received the wireless signal 117 via the antenna 102outputs a reception beacon signal 118 to the digital filter 107. At the same time, the wireless reception unit 104 checks the header needed in the wireless LAN after demodulation and recognizes the presence or absence of an error. When there is no error, the wireless reception unit 104 outputs a reception frame body signal 119 to the frame body disassembly unit 109.

It is to be noted that the beacon signal is a control signal used between different wireless apparatus. Each of the wireless apparatus synchronizes based on the beacon signal and controls timing for transmission data.

On receiving the reception beacon signal 118, the digital filter 107 generates a corrected reception beacon signal 121 by correcting fluctuations that have occurred in a wireless section and outputs the corrected reception beacon signal 121 to the packet read control unit 110.

On receiving the corrected reception beacon signal 121, the packet read control unit 110 synchronizes a reception time stamp timer (not shown) provided in the packet read control unit 110 with the corrected reception beacon signal 121. The packet read control unit 110 further generates a packet read signal 122 showing timing for reading a packet from the result of a comparison between the reception time stamp timer and a reception time stamp 120 inputted from the frame body disassembly unit 109 and outputs the packet read signal 122 to the frame body disassembly unit 109.

The frame body disassembly unit 109 disassembles the reception frame body signal 119, which is either the single time-stamp-added packet 114 or the assembly of the plurality of time-stamp-added packets 114, into the individual discrete time-stamp-added packets 114. The frame disassembly unit 109 further outputs the time stamp added to each of the time-stamp-added packets 114 as the reception time stamp 120 to the packet read control unit 110. On receiving the packet read signal 122 from the packet read control unit 110, the frame body disassembly unit 109 generates a packet by removing the reception time stamp 120 from each of the time-stamp-added packets 114 and outputs the generated packet as a packet output 113.

In the manner described above, the wireless apparatus 101, which implements wireless transmission, performs data processing by using the wireless clock 111 at a fixed frequency. That is, each of the time stamp add unit 106, the frame body assembly unit 105, the wireless transmission unit 103, the wireless reception unit 104, the digital filter 107, the packet read control unit 110, and the frame body disassembly unit 109 operates based on the wireless clock 111.

The foregoing description has been given thus far to the transmission and reception performed in the wireless apparatus 101. Intrinsically, however, the wireless signal 117 transmitted from the wireless apparatus 101 is received by the other wireless apparatus 101x. The other wireless apparatus 101x is provided with another fixed-frequency wireless clock 111x and controlled thereby. It follows therefore that the transmitting operation and the receiving operation are controlled by the different clocks.

FIG. 18 is a view for illustrating the operation of a wireless apparatus connected to a conventional wired network.

FIG. 18 shows the connection among a wireless LAN 202, a wired network 212, and a wireless LAN 217. The wireless LAN 202 is composed of a wireless apparatus 1 (STA) 203 and a wireless apparatus 2 (AP) 207. The wireless LAN 217 is composed of a wireless apparatus 3 (AP) 218 and a wireless apparatus 4 (STA) 221. The STA represents a station. The AP represents an access point.

The operation of such a network will be described herein below.

Each of the wireless apparatus 1 (STA) 203, the wireless apparatus 2 (AP) 207, the wireless apparatus 3 (AP) 218, and the wireless apparatus 4 (STA) 221 has the same structure as the wireless apparatus 101 shown in, e.g., FIG. 17. Additionally, each of the wireless apparatus 2 (AP) 207 and the wireless apparatus 3 (AP) 218 has the function of communicating with the wired network 212.

The wireless apparatus 1 (STA) 203 and the wireless apparatus 2 (AP) 207 are synchronized with each other via a wireless signal 206 including a beacon signal which is generated by the wireless apparatus 2 (AP) 207.

A data clock 204 for processing an audio-video data input 201 in the wireless apparatus 1 (STA) 203 also operates based on the beacon signal mentioned above so that the audio-video data input 201 is formed into a packet based on the data clock 204. The audio-video data input 201 in the form of a packet is transmitted to the wireless apparatus 2 (AP) 207 via the wireless signal 206.

The wireless apparatus 2 (AP) 207 extracts the audio-video signal packet from the wireless signal 206 and outputs the extracted audio-video signal packet as wired data 209 to the wired apparatus 210. The wired apparatus 210 processes the wired data 209 in accordance with a wired data format and further transmits the wired data 209 to the wired network 212 via a wired line 211. The wired network 212 transmits the data received via the wired line 211 and further outputs the received data to a wired apparatus 215 via a wired line 214. The wired apparatus 215 outputs the received data as wired data 216 to the wireless apparatus 3 (AP) 218.

The wireless apparatus 3 (AP) 218 and wireless apparatus 4 (STA) 221 of the wireless LAN 217 are synchronized with each other via a wireless signal 220 including a beacon signal which is generated by the wireless apparatus 3 (AP) 218.

The wireless apparatus 3 (AP) 218 transmits the wired data 216 received from the wired apparatus 215 to the wireless apparatus 4 (STA) 221 via the wireless signal 220. The wireless apparatus 4 (STA) 221 decodes the data in the form of a packet from the wireless signal 220 based on a wireless clock 222 and a data clock 223 and outputs the decoded data as an audio-video data output 224.

The wired network 212 is a network which guarantees a bandwidth synchronized by the wired clock 213.

As examples of documents related to this technical field, there can be listed Japanese Unexamined Patent Publication Nos. 2005-39633 and 2003-60652, Japanese Examined Patent Publication No. HEI 6-18339, Japanese Patent No. 3160146, and the like.

### SUMMARY OF THE INVENTION

However, the conventional wireless apparatus 101 shown in FIG. 17 has the following problems.

The digital filter 107 of the receiver generates the corrected reception beacon signal 121 by correcting, based on the wireless clock of the receiver, the transmission beacon signal 115 generated based on the wireless clock of the transmitter. However, the wireless clock 111 provided in the conventional wireless apparatus 101, which performs wireless communication, is an asynchronous clock. That is, the wireless clock of the transmitter and the wireless clock of the receiver are out of synchronization. As a result, fluctuations in clock width and fluctuations in the time accuracy range of the beacon signal occur in the corrected reception beacon signal 121 outputted from the digital filter 107. The fluctuations are eventually transmitted to the packet output 113 and degrade the reliability of wireless communication and the like.

On the other hand, of the wireless apparatus connected to the conventional wired network shown in FIG. 18 to transmit the audio-video data, the wireless apparatus 2 (AP) 207 of the wireless LAN connected to the wired network 212 and the beacon signal generated by the wireless apparatus 3 (AP) 218 are out of synchronization. In addition, the wireless clock 208 provided in the wireless apparatus 2 (AP) 207 and the wireless clock 219 provided in the wireless apparatus 3 (AP) 218 are also out of synchronization.

Accordingly, the wireless clock 222 and the data clock 223 each provided in the wireless apparatus 4 (STA) 221 as the receiver which reproduces an audio-video signal are not synchronized with the wireless clock 205 and the data clock 204 each provided in the wireless apparatus 1 (STA) 203, respectively.

As a result, the packet interval (data bandwidth) is not guaranteed and there is the possibility that the audio-video data 224 with degraded characteristics is decoded. In other words, the mutually asynchronous clocks may cause the degradation of an image resulting from, e.g., reproduction with some image frames omitted, the freezing of an image, or the like.

It is therefore an object of the present invention to provide a wireless apparatus and a wireless method which allow the suppression of packet fluctuations and a real-time guarantee of the data bandwidth.

A wireless apparatus according to the present invention comprises: a wireless reception unit for receiving a wireless signal including a frame body signal having a packet with a time stamp added thereto and a beacon signal, extracting the frame body signal and the beacon signal from the wireless signal; a frame body disassembly unit for extracting the time stamp and the packet from the extracted frame body signal and outputting the extracted time stamp and the extracted packet; a packet read control unit for generating a packet read signal inputted to the frame body disassembly unit to control the outputting of the packet based on the extracted time stamp and outputting the packet read signal; and a wireless reference clock generation unit for generating a wireless clock and outputting the wireless clock to the wireless reception unit, the frame body disassembly unit, and to the packet read control unit, wherein the wireless reference clock generation unit selects either one of a free-running master clock and a clock which is synchronized with the beacon signal by using a PLL (Phase Locked Loop) and outputs the selected one as the wireless clock.

Since the wireless apparatus according to the present invention allows synchronization between the wireless clock thereof and that of another wireless apparatus which has transmitted the wireless signal received thereby, it becomes possible to suppress packet fluctuations and guarantee a data bandwidth. This allows real-time high-quality wireless communication, e.g., transfer of audio-video data, which will be described herein below to be performed.

The wireless reference clock generation unit provided in the wireless apparatus according to the present invention can generate the clock which is synchronized with the beacon signal included in the received wireless signal and can also select either one of the clock and a free-running masker clock and output the selected one. The beacon signal is generated based on another wireless clock provided in the other wireless apparatus which has transmitted the wireless signal. It follows therefore that the clock which is synchronized with the beacon signal is also synchronized with the other wireless clock provided in the other wireless apparatus.

The time stamp included in the received wireless signal is generated and added based on the other wireless clock in the other wireless apparatus that has transmitted the wireless signal. Accordingly, packet fluctuations can be suppressed by adding the time stamp using the wireless clock which is synchronized with the other wireless clock, i.e., by controlling the packet interval based on the difference between the time stamp values. The control of the packet interval based on the difference between the time stamp values indicates a control operation such that, when consideration is given to a first packet and a second packet received after the reception of the first packet, the difference between the time stamp values of the first and second packets is determined and, after the first packet is outputted, the second packet is outputted after the lapse of a time corresponding to the difference between the time stamp values.

In one aspect, the wireless apparatus according to the present invention preferably further comprises: a time stamp add unit for adding a transmission time stamp to a packet input in accordance with a transmission beacon signal and outputs the packet input as a time-stamp-added packet; a frame body assembly unit for generating a transmission frame body signal including the at least one time-stamp-added packet outputted from the time stamp add unit and outputting the transmission frame body signal; and a wireless transmission unit for generating the transmission beacon signal, outputting the transmission beacon signal to the time stamp add unit, and wirelessly transmitting the transmission beacon signal and the transmission frame body signal.

The arrangement allows the wireless apparatus according to the present invention to also perform the transmission of the wireless signal. By using the two wireless apparatus according to the present invention, transmission and reception for wireless communication with reduced packet fluctuations can be performed. The transmission time stamp, the transmission frame body signal, and the transmission beacon signal added or generated in the transmitter wireless apparatus are received as the time stamp, the frame body signal, and the beacon signal by the receiver wireless apparatus.

In still another aspect, the wireless apparatus according to the present invention preferably further comprises: a time stamp add unit which comprises a timer unit for a time stamp, adds a transmission time stamp to a packet input based on the timer unit for a time stamp, and outputs the packet input as a time-stamp-added packet; a frame body assembly unit for generating a transmission frame body signal including the at least one time-stamp-added packet outputted from the timer stamp add unit; and a wireless transmission unit for generating a transmission beacon signal and wirelessly transmitting the transmission beacon signal and the transmission frame body signal.

The timer unit for time stamp can perform counting based on the wireless clock which is higher in time accuracy than the transmission beacon signal generated in the wireless transmission unit. This allows the wireless apparatus to perform transmission and also perform packet control even in the case of using a bandwidth which requires the control of the packet interval shorter than the time interval between the transmission beacon signals. This also allows more reliable suppression of packet fluctuations.

In yet another aspect, the wireless apparatus according to the present invention preferably further comprises: means for detecting a change in a beacon period based on a beacon interval included in the beacon signal; and means for setting a parameter for the PLL in the wireless reference clock generation unit in response to the change in the beacon period, wherein the wireless reference clock generation unit generates the wireless clock in accordance with the parameter.

The arrangement allows the synchronization of the wireless clock with the transmitter wireless apparatus to be maintained even when the beacon period is changed and allows wireless communication with reduced packet fluctuations to be performed.

Likewise, the wireless apparatus according to the present invention preferably further comprises: means for changing a beacon period in accordance with a packet bandwidth; means for reporting the beacon period by using a beacon interval; means for detecting a change in the beacon period based on the beacon interval included in the beacon signal; and means for setting a parameter for the PLL in the wireless reference clock generation unit in response to the change in the beacon period, wherein the wireless reference clock generation unit generates the wireless clock in accordance with the parameter.

When the wireless signal is transmitted, the arrangement allows the beacon period to be changed in accordance with the difference between packet bandwidths and allows an improvement in communication efficiency. That is, when the packet bandwidth is large, the ratio of the transmission beacon signal to the time-stamp-added packet to be transmitted can be reduced by increasing the beacon period. Accordingly, a larger number of packets can be transmitted even by using the same packet bandwidth. In addition, since the change in beacon period is reported by using the beacon interval, the change in beacon period can be detected in the receiver wireless apparatus based on the beacon interval.

When the wireless signal is received, the synchronization of the wireless clock with the transmitter wireless apparatus can be maintained in accordance with the change in beacon period. Accordingly, wireless communication with reduced packet fluctuations can be performed.

In still another aspect, the wireless apparatus according to the present invention preferably further comprises: means for counting the beacon period based on the beacon signal; and means for detecting a beacon loss based on the beacon interval included in the beacon signal and on a count of the beacon period, wherein the wireless reference clock generation unit continues to output the same wireless clock as outputted before the detection of the beacon loss when the beacon loss is detected.

When the beacon loss is detected, i.e., when the beacon signal cannot be detected any more, the arrangement continued to output the same wireless clock as outputted before the beacon loss is detected. As a result, even when the beacon signal cannot be detected any more, a stable wireless clock can be generated without receiving serious influence therefrom. Normally, the communication status of the beacon signal is not monitored by using an ACK signal (receipt acknowledgment) so that, even when the beacon signal is lost, it cannot be acquired again. Therefore, the capability of generating a stable wireless clock even when the beacon signal is lost achieves a remarkable effect for communication with reduced packet fluctuations.

In yet another aspect, the wireless apparatus according to the present invention preferably further comprises: means for requesting switching of a wireless channel based on the beacon signal and on the detection of the beacon loss, wherein the means for detecting the beacon loss detects cancellation of the beacon loss after the switching of the wireless channel and the wireless reference clock generation unit outputs the master clock as the wireless clock when the wireless channel is switched and outputs the clock which is synchronized with the beacon signal as the wireless clock after the beacon loss is cancelled.

The arrangement allows a stable wireless clock to be outputted in accordance with the free-running master clock when the wireless channel is switched and also allows the wireless clock which is synchronized with the beacon signal to be outputted again after the switching of the wireless channel is completed. As a result, it becomes possible to reliably perform the switching of the wireless channel based on the beacon loss and also suppress packet fluctuations when the wireless channel is switched.

In still another aspect, the wireless apparatus according to the present invention preferably further comprises: means for generating a data clock for processing an audio-video signal formed into the packet, wherein the data clock is synchronized with the wireless clock.

By thus processing the audio-video signal based on the data clock which is higher in time accuracy than the beacon signal, fluctuations can be further suppressed than in the case where the processing is performed based on the beacon signal. As a result, when the audio-video signal is received and reproduced, the occurrence of the characteristic degradation thereof can be further suppressed.

In yet another aspect, the wireless apparatus according to the present invention preferably further comprises: means for generating a wireless clock which is synchronized with a wired network based on a wired synchronous phase reference signal in the wired network.

With the arrangement, even in the wireless apparatus connected to the wired network to communicate data such as audio-video data, packet fluctuations can be suppressed and the data bandwidth can be guaranteed. As a result, when the audio-video signal is communicated, the characteristic degradation of the audio-video signal during the reproduction thereof can be suppressed.

A monitor camera system according to the present invention comprises: a camera for acquiring audio-video data; a monitor apparatus for displaying the audio-video data;

and a wireless apparatus for transmitting the audio-video data from the camera to the monitor apparatus, wherein the wireless apparatus is the wireless apparatus according to any of the aspects of the present invention.

The monitor camera system according to the present invention allows real-time high-definition transmission of the audio-video data by using the wireless apparatus according to the present invention provided in each of the camera and the monitor apparatus. Therefore, the monitor camera system according to the present invention is useful as a system for monitoring an image and a sound at a remote location.

The monitor camera system according to the present invention may further comprise a recording apparatus for recording audio-video data transmitted from the camera via wireless communication in a recording medium such as a DVD (Digital Versatile Disc). This allows real-time high-definition recording of audio/video data which is wirelessly transmitted from a remote location.

An audio-video listening and viewing system according to the present invention comprises: a reproduction apparatus for reproducing audio-video data; a monitor apparatus for displaying the audio-video data; and a wireless apparatus for transmitting the audio-video data from the reproduction apparatus to the monitor apparatus, wherein the wireless apparatus is the wireless apparatus according to any of the aspects of the present invention.

With the audio-video listening and viewing system according to the present invention, it becomes possible to implement an audio-video listening and viewing system which allows real-time high-definition listening and viewing of the audio-video data even when it is wirelessly transmitted by using the wireless apparatus according to the present invention provided in each of the reproduction apparatus for reproducing the audio-video data from a recording medium such as a DVD and the monitor apparatus.

Thus, the wireless apparatus according to the present invention allows synchronization between the wireless clock thereof and that of a communication partner with which it performs wireless communication and thereby allows the suppression of packet fluctuations when packet interval control based on the difference between the time stamps is performed and the execution of high-quality data transmission. This can be implemented with a relatively small increase in the hardware scale of the PLL circuit for the wireless clock.

### BRIEF DESCRIPTION OF THE DRAWINGS

FIG. 1 is a view showing the structure of a wireless apparatus according to a first embodiment of the present invention;

FIG. 2 is a view showing a structure of a wireless reference clock generation unit in the wireless apparatus according to the first embodiment;

FIG. 3 is a flow chart illustrating the operation of the wireless apparatus according to the first embodiment;

FIG. 4 is a view illustrating the structure of a wireless clock in the wireless apparatus according to the first embodiment;

FIG. 5 is a view showing the structure of a wireless apparatus according to a second embodiment of the present invention;

FIG. 6 is a view showing the structure of a wireless apparatus according to a third embodiment of the present invention;

FIG. 7 is a view illustrating a beacon-period changing operation in the wireless apparatus according to the third embodiment;

FIG. 8 is a view showing a structure of the wireless reference clock generation unit in the wireless apparatus according to the third embodiment;

FIG. 9 is a view showing the structure of a wireless apparatus according to a fourth embodiment of the present invention;

FIG. 10 is a view illustrating a clock protecting operating during a beacon loss in the wireless apparatus according to the fourth embodiment;

FIG. 11 is a view showing the structure of a wireless apparatus according to a fifth embodiment of the present invention;

FIG. 12 is a view for illustrating the clock protecting operation during channel switching in the wireless apparatus according to the fifth embodiment;

FIG. 13 is a view showing the structure of a wireless apparatus according to a sixth embodiment of the present invention;

FIG. 14 is a view showing the structure of a wireless apparatus according to a seventh embodiment of the present invention;

FIG. 15 is a view showing the connection of the wireless apparatus according to the seventh embodiment to a wired network;

FIG. 16 is a view showing a monitor camera system which communicates audio-video data by using the wireless apparatus according to the seventh embodiment;

FIG. 17 is a view showing a structure of a conventional wireless apparatus; and

FIG. 18 is a view showing the connection of a conventional wireless apparatus to a wired network.

### DETAILED DESCRIPTION OF THE INVENTION

Referring to the drawings, the individual embodiments of the present invention will be described herein below.

### Embodiment 1

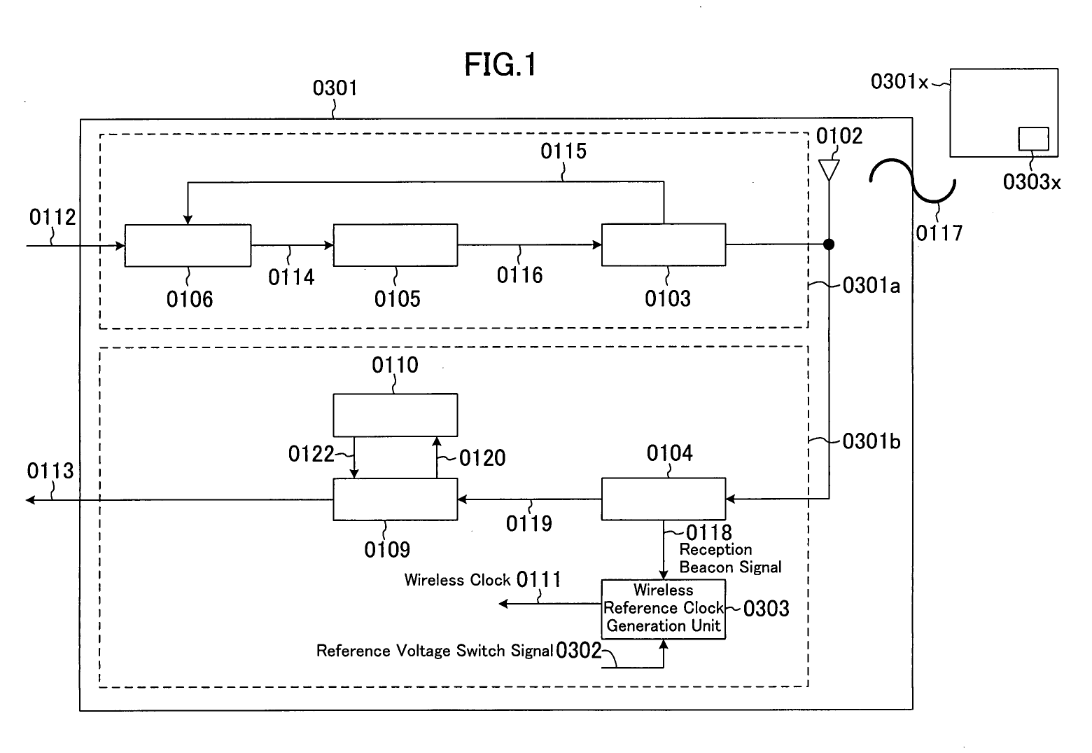

FIG. 1 schematically shows the structure of a wireless apparatus according to the first embodiment of the present invention. A wireless apparatus 0301 has a transmission functional portion 0301a and a reception functional portion 0301b, which respectively perform a transmission process and a reception process each by using an antenna 0102.

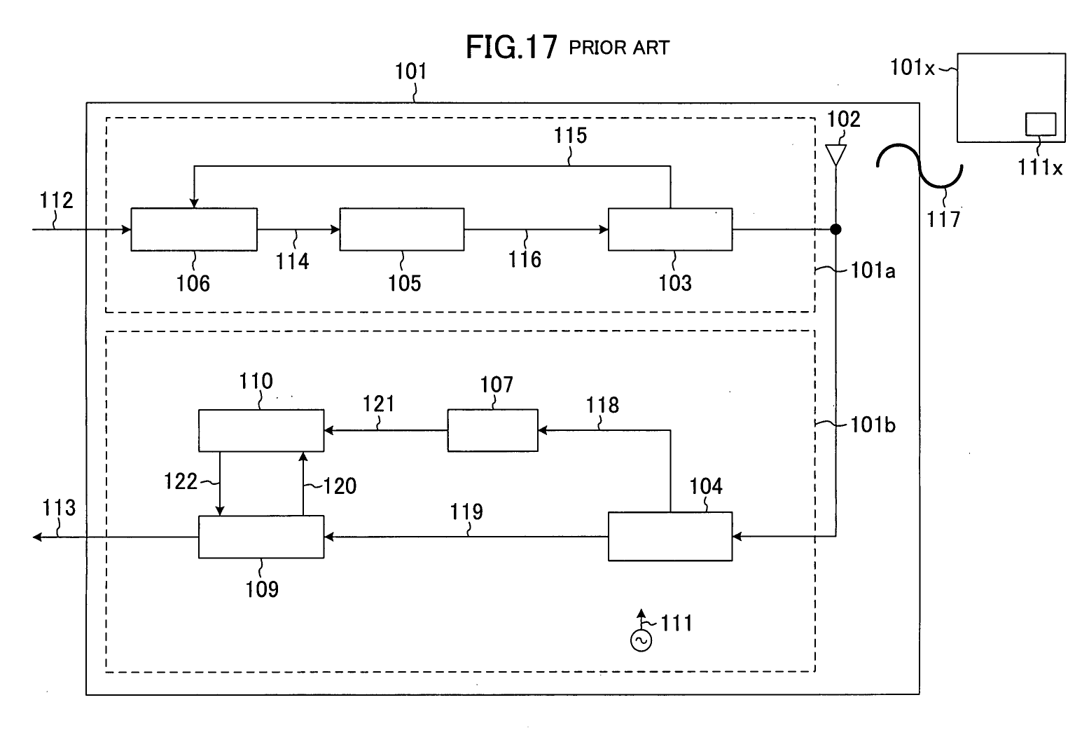

The transmission functional portion 0301a is the same as the transmission functional portion 101a in the conventional wireless apparatus 101 shown in FIG. 17.

Accordingly, the transmission functional portion 0301a comprises a time stamp add unit 0106, a frame body assembly unit 0105, and a wireless transmission unit 0103. Compared with the conventional reception functional portion 101b, the reception functional portion 0301b does not comprise the digital filter 107 but comprises a wireless reference clock generation unit. Accordingly, the reception functional portion 0301b comprises a wireless reference clock generator 0303 in addition to a wireless reception unit 0104, a frame body disassembly unit 0109, and a packet read control unit 0110.

Each of the wireless transmission unit 0103 and the wireless reception unit 0104 comprises an RF (Radio Frequency), a baseband, each of which is a physical layer, and a layer-2 processor for processing a data link layer, though they are not depicted.

A description will be given herein below to a wireless method as the operation of the wireless apparatus 0301 according to the present embodiment having a structure as described above. For simplified illustration, transmitting and receiving operations according to the present embodiment will also be described collectively by using only the wireless apparatus 0301 depicted in detail, in the same manner as described in the prior art technology by using the conventional wireless apparatus 101. That is, a wireless signal 0117 transmitted from the wireless apparatus 0301 is intrinsically received by another wireless apparatus 0301x, while a wireless signal transmitted from the other wireless apparatus 0301x is also intrinsically received by the wireless apparatus 0301. However, instead of describing the transmitting and receiving operations by depicting each of the wireless apparatus 0301 and the other wireless apparatus 0301x in detail, the transmission and reception will be described herein by using only the depiction of the wireless apparatus 0301.

The transmitting operation by the transmission functional portion 0301a is the same as in the conventional wireless apparatus 101. The transmitting operation will be described herein below.

A packet input 0112 to the wireless apparatus 0301 is inputted first to the time stamp add unit 0106. The time stamp add unit 0106 generates a time-stamp-added packet 0114 by adding a time stamp to the packet input 0112 and outputs the time-stamp-added packet 0114 toward the frame body assembly unit 0105. As a result, a transmission beacon signal 0115 is inputted from the wireless transmission unit 0103 to the time stamp add unit 0106. Based on the transmission beacon signal 0115, the time stamp is added in accordance with the input timing of the packet input 0112. More specifically, the value of the transmission beacon signal 0115 is held at the time at which the packet input 0112 is inputted.

The frame body assembly unit 0105 generates a transmission frame body signal 0116 for a wireless LAN from a single time-stamp-added packet 0114 or an assembly of a plurality of time-stamp-added packets 0114 inputted from the time stamp add unit 0106 and outputs the transmission frame body signal 0116 to the wireless transmission unit 0103. The wireless transmission unit 0103 adds a header needed in the wireless LAN to the transmission frame body signal 0116 inputted from the frame body assembly unit 0105, further modulates the transmission frame body signal 0116 with the header, and transmits the modulated transmission frame body signal 0116 as the wireless signal 0117 via the antenna 0102.

The wireless signal 0117 is received by the other wireless apparatus 0301x.

However, the description will be given instead to the substitute case where the wireless apparatus 0301 has received the wireless signal 0117, as stated previously.

The wireless reception unit 0104 that has received the wireless signal 0117 via the antenna 0102 extracts the beacon signal (transmission beacon signal 0115) and the frame body signal (transmission frame body signal 0116) from the wireless signal 0117 as a reception beacon signal 0118 and a reception frame body signal 0119, respectively., and outputs them More specifically, the present embodiment outputs the reception fame body signal 0119 toward the fame body disassembly unit 0109, similarly to the conventional embodiment, while outputting the reception beacon signal 0118 toward the wireless reference clock generation unit 0303, unlike the conventional embodiment which has outputted the reception beacon signal toward the digital filter.

As will be described later in detail, the wireless reference clock generation unit 0303 is capable of outputting a wireless clock 0111, which is synchronized with the wireless clock of the transmitter wireless apparatus by using a PLL circuit, based on the reception beacon signal 118 inputted from the wireless reception unit 0104.

The wireless clock 0111 thus generated is used in each of the wireless transmission unit 0103 and the wireless reception unit 0104, as will also be described later.

In addition, the wireless reference clock generation unit 0303 is also capable of generating a free-running clock and outputting it as the wireless clock 0111, as will also be described later. The selection of which one is to be outputted as the wireless clock 0111 is performed in accordance with a reference voltage switch signal 0302.

The frame body disassembly unit 0109 to which the reception frame body signal 0119 has been inputted disassembles the reception frame body signal 0119, which is either the single time-stamp-added packet 0114 or the assembly of the plurality of time-stamp-added packets 0114, into the individual discrete time-stamp-added packets 0114. The frame body disassembly unit 0109 further outputs the time stamp added to each of the time-stamp-added packets 0114 as a reception time stamp 0120 to the packet read control unit 0110. These operations are the same as in the conventional wireless apparatus 101.

The packet read control unit 0110 that has received the reception time stamp 0120 generates a packet read signal 0122 and outputs it toward the frame body disassembly unit 0109. In contrast to the conventional embodiment which has generated the packet read signal 122 based on the corrected beacon signal 121, the present embodiment generates the packet read signal 0122 by using the wireless clock 0111 synchronized with the wireless clock of the transmitter in accordance with a time interval based on the differences between the individual reception time stamps. That is, when consideration is given to a first packet and to a second packet received after the reception of the first packet, a control operation is performed such that the difference between the respective time stamp values of the first and second packets is determined and, after the first packet is outputted, the second packet is outputted after the lapse of a time corresponding to the difference between the time stamp values. Since the respective wireless clocks of the transmitter wireless apparatus which has added the time stamp values and the receiver wireless apparatus are synchronized with each other, packet fluctuations can be suppressed reliably.

On receiving the packet read signal 0122, the frame body disassembly unit 0109 generates a packet by removing the reception time stamp 0120 from each of the time-stamp-added packets 0114 and outputs the generated packet as a packet output 0113.

Thus, the present embodiment performs the receiving process by using the wireless clock 0111 synchronized with the wireless clock of the transmitter wireless apparatus and thereby allows wireless communication with reduced packet fluctuations to be performed. Therefore, the present embodiment is particularly useful for real-time data communication.

The wireless apparatus 0301 according to the present embodiment comprises both the transmission functional portion 0301a and the reception functional portion 0301b to serve as a wireless apparatus capable of performing both transmission and reception.

In the case where it is unnecessary to transmit data which requires a bandwidth guarantee (such as audio-video data) but it is necessary to perform reception, the wireless apparatus is allowed to receive data with a bandwidth guarantee and suppress the characteristic degradation of the audio-video data during the reproduction thereof by comprising the reception functional portion 0301b and the antenna 0102.

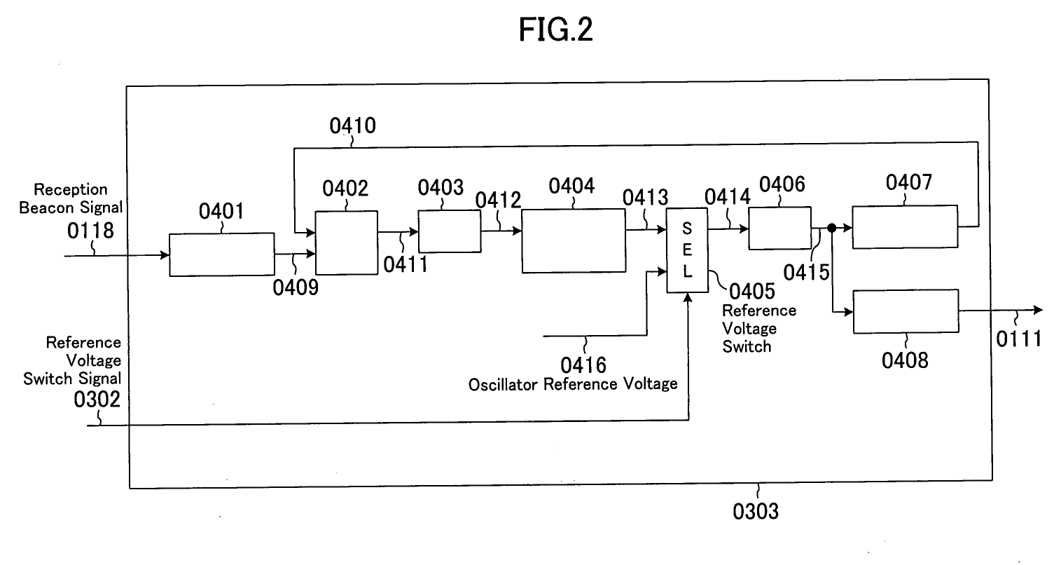

A description will be given next to the structure and operation of the wireless reference clock generation unit 0303 with reference to FIG. 2.

The reception beacon signal 0118 inputted to the wireless reference clock generation unit 0303 has the frequency thereof divided by a reference clock frequency divider 0401 and is outputted as a reference clock frequency-divided signal 0409. The reference clock frequency-divided signal 0409 is compared with a generated clock frequency-divided signal 0410 in a phase comparator 0402 so that a phase comparison signal 0411 is outputted from the phase comparator 0402. The phase comparison signal 0411 is inputted to a low pass filter 0403, from which a gain signal 0412 is outputted. The gain signal 0412 is inputted to a voltage conversion circuit 0404, from which a gain control voltage 0413 is outputted. The gain control voltage 0413 generated based on the gain signal 0412 is generated to control an oscillator 0406.

Subsequently, the gain control voltage 0413 is inputted to a reference voltage switch (SEL) 0405. To the reference voltage switch 0405, an oscillator reference voltage 0416 has also been inputted so that either one of the gain control voltage 0413 and the oscillator reference voltage 0416 is selected in accordance with the reference voltage switch signal 0302 and the selected one is outputted as an oscillator control voltage 0414.

The oscillator control voltage 0414 is inputted to the oscillator 0406 so that the oscillator 0406 generates a generated clock 0415 controlled by the oscillator control voltage 0414.

The generated clock 0415 is inputted to a generated clock frequency divider 0407, in which the frequency thereof is divided and the generated clock frequency-divided signal 0410 to be compared with the reference clock frequency-divided signal 0409 in the phase comparator 0402 is generated. At the same time, the generated clock 0415 is also inputted to a wireless clock generator 0408, in which the frequency thereof is divided or multiplied and the wireless clock 0111 used in the wireless apparatus 0301 is generated.

The oscillator reference voltage 0416 inputted to the reference voltage switch 0405 is a control voltage for the oscillator 0406 when the wireless clock 0111 which does not allow synchronization with a communication partner (the wireless clock of the transmitter wireless apparatus) is used (i.e., when the wireless apparatus 0301 is the master). This provides a fixed voltage for generating a fixed frequency in accordance with the standard.

The reference voltage switch signal 0302 is a signal for selecting either one of the gain control voltage 0413 and the oscillator reference voltage 0416. With the reference voltage switch signal 0302, either one of the wireless clock 0111 which is synchronized with the communication partner and the wireless clock 0111 which is the master is selected.

In other words, the reference voltage switch signal 0302 allows the selection of whether the wireless apparatus 0301 is to be synchronized with the communication partner or not.

Thus, the wireless reference clock generation unit 0303 allows either one of the free-running master clock and the clock synchronized with the reception beacon signal to be selected and outputted as the wireless clock. Since the reception beacon signal 0118 has been generated based on the wireless clock of the transmitter wireless apparatus, it follows that the clock synchronized with the reception beacon signal 0118 is also synchronized with the wireless clock of the transmitter.

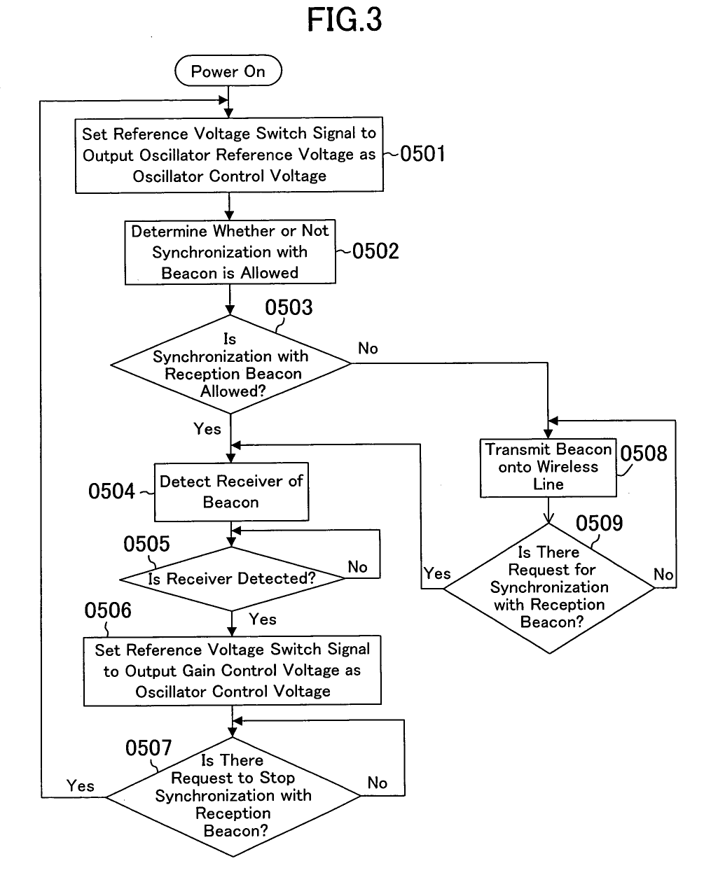

FIG. 3 is a view for illustrating a control method for the reference voltage switch signal 0302 for controlling the wireless reference clock generation unit 0303 provided in the wireless apparatus 0301 according to the present embodiment. After turning on the power source of the wireless apparatus 0301, a master clock process 0501 is performed first to control the reference voltage switch signal 0302 such that the oscillator reference voltage 0416 is outputted as the oscillator control voltage 0414.

Next, a beacon synchronization setting process 0502 determines whether or not synchronization with the reception beacon signal 0118 is allowed as a determination 0503 of beacon synchronization setting. As a result, when synchronization is not allowed, i.e., when the wireless signal 0111 serving as the master is used, a process 0508 of transmitting the beacon signal onto a wireless line is performed. On the other hand, when synchronization is allowed, a process 0504 of searching for the receiver of the beacon is performed.

A description will be given first to the case where the process 0508 of transmitting the beacon signal onto the wireless line is performed. In this case, the beacon signal is transmitted with the period of the beacon interval onto the wireless line via the antenna 0102. At the same time, it is determined by a synchronization request detection 0509 whether or not there is a request for synchronization with the beacon signal. When the request for synchronization with the reception beacon is detected, the process 0504 of searching for the receiver of the beacon is performed. When there is no request for synchronization with the reception beacon, the whole flow returns to the process 508 of transmitting the beacon signal onto the wireless line and repeats the process.

Next, in the process 0504 of searching for the receiver of the beacon, a communication partner is detected in the determination 0505 of the receiver of the beacon. When a communication partner is not detected, the process 0504 is repeated. When a communication partner is detected, a process 0506 of selecting the oscillator control voltage is performed.

In the process 0506 of selecting the oscillator control voltage, the reference voltage switch signal 0302 is set such that the gain control voltage 0413 is selected and outputted as the oscillator control voltage 0414. As a result, the wireless clock 0111 is synchronized with the reception beacon signal. Thereafter, a process 0507 of searching for a request to stop synchronization with the beacon signal is performed to detect whether or not there is a request to stop synchronization with the reception beacon. When there is a request to stop synchronization with the reception beacon, the whole flow returns to the master clock process 0501 and executes it.

The foregoing is the method for controlling the reference voltage switch signal 0302 for selecting either one of the clock synchronized with the reception beacon and the free-running mater clock.

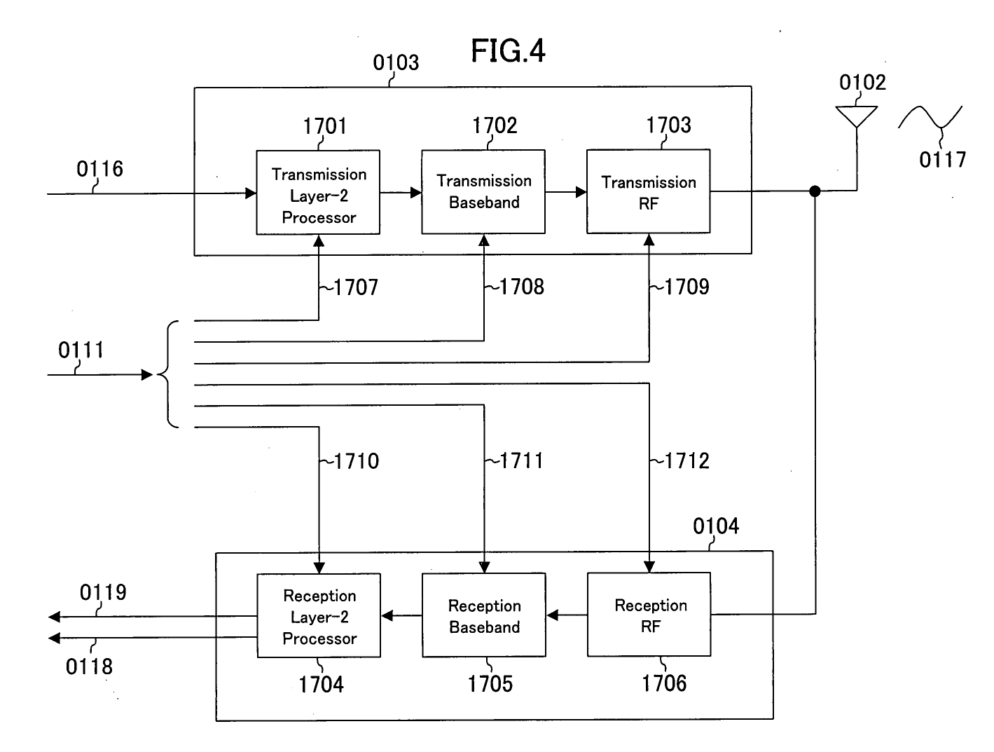

A further description will be given to the wireless clock 0111 with reference to FIG. 4. The wireless clock 0111 is inputted to and used in each of the time stamp add unit 0106, the frame body assembly unit 0105, the frame body disassembly unit 0109, and the packet read control unit 0110, while it is also used in respective circuits composing the wireless transmission unit 0103 and the wireless reception unit 0104. Specifically, the wireless clock 0111 is used also in a transmission layer-2 processor 1701, a transmission baseband 1702, and a transmission RF 1703 each composing the wireless transmission unit 0103 and in a reception layer-2 processor 1704, a reception baseband 1705, and a reception RF 1706 each composing the wireless reception unit 0104. To these circuits, the individual clocks included in the wireless clock 0111, i.e., a transmission layer-2 processor clock 1707, a transmission baseband clock 1708, a transmission RF clock 1709, a reception layer-2 processor clock 1710, a reception baseband clock 1711, and a reception RF clock 1712 are inputted in this order and used for the processing of data.

In the manner described above, packet fluctuations between the different wireless apparatus resulting from the mutually asynchronous wireless clocks can be suppressed.

### Embodiment 2

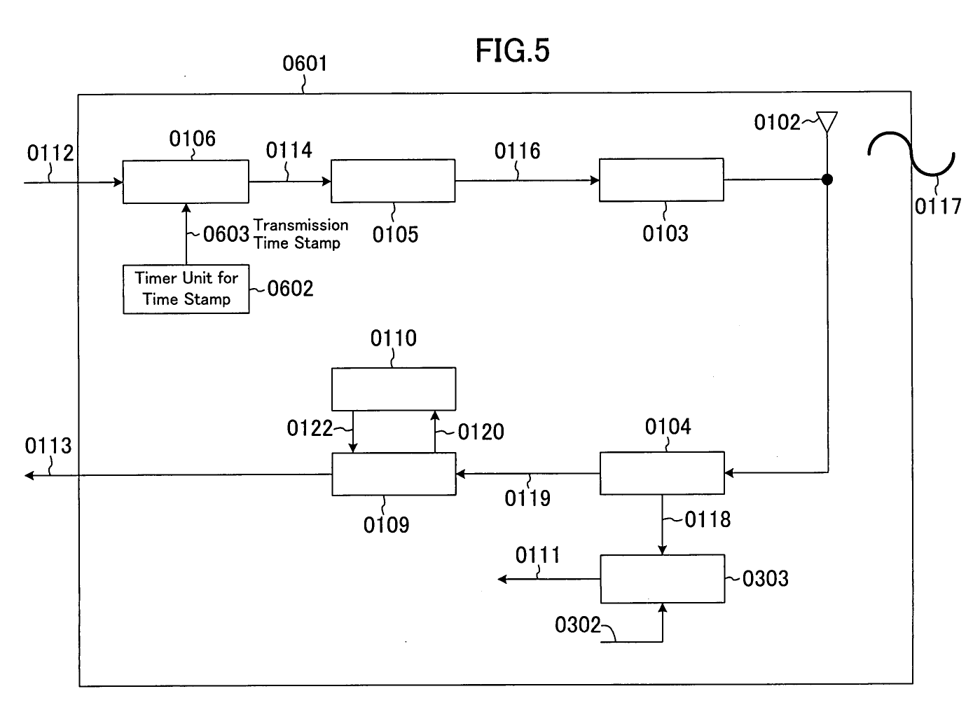

A description will be given next to a wireless apparatus according to the second embodiment of the present invention and to the operation thereof. FIG. 5 diagrammatically shows the structure of a wireless apparatus 0601 according to the second embodiment. The wireless apparatus 0601 has a structure in which a timer unit 0602 for time stamp is further provided in addition to the components of the wireless apparatus 0301 according to the first embodiment shown in FIG. 1. Accordingly, a detailed description will be given herein below to the timer unit 0602 for time stamp, while omitting the detailed description of the components other than the timer unit 0602 for time stamp by retaining the same reference numerals as used in FIG. 1. In the present embodiment also, the transmitting and receiving operations will be described by using only the depiction of the wireless apparatus 0601, while the depiction of the transmission functional portion 0301a, the reception functional portion 0301b, and the other wireless apparatus as the communication partner of the wireless apparatus 0601 is omitted.

The timer unit 0602 for time stamp generates a transmission time stamp 0603. The transmission time stamp 0603 has a time stamp value as transmission time information based on the wireless clock 0111 of the transmitter.

The packet input 0112 is inputted to the time stamp add unit 0106 in which a time stamp is added thereto so that the time-stamp-added packet 0114 is outputted therefrom. In contrast to the first embodiment which has added the time stamp based on the transmission beacon signal 0115, the present embodiment adds the time stamp based on the transmission time stamp 0603 generated by the timer unit 0602 for time stamp.

Except for that, the wireless apparatus 0601 according to the present embodiment operates in the same manner as in the first embodiment.

The transmission time stamp 0603 has the wireless accuracy of the wireless clock 0111 which is higher in time accuracy than the transmission beacon signal 0115. In the case of adopting the IEEE 802.11, the time accuracy of the beacon timer counter for generating the transmission beacon signal 0115 is 1 μS (1 MHz), while the wireless clock 0111 used by the baseband for modulation, demodulation, a transmission/reception filter, and the like is 40 MHz. Accordingly, packet control can be performed with higher accuracy. Even in the case of using a bandwidth which is shorter in packet interval than when the time stamp is added by using the transmission beacon signal 0115, packet control can be performed for necessary data. This allows more reliable suppression of packet fluctuations and a more reliable guarantee of a data bandwidth than in the first embodiment.

### Embodiment 3

A description will be given next to a wireless apparatus according to the third embodiment of the present invention and to the operation thereof.

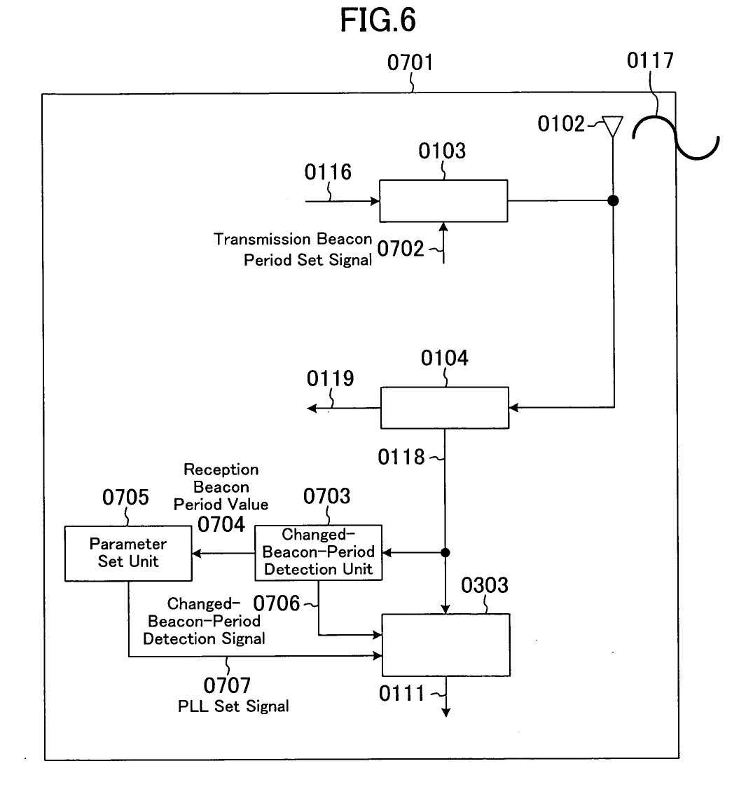

FIG. 6 shows a wireless apparatus 0701 according to the third embodiment. The wireless apparatus 0701 has a structure including components common to the wireless apparatus 0301 according to the first embodiment and further including several other components added thereto. Therefore, FIG. 6 primarily shows a portion characteristic of the wireless apparatus 0701 according to the present embodiment, while omitting the depiction of a part thereof. The present embodiment will also describe the transmission and reception of a wireless signal by using only the wireless apparatus 0701 of FIG. 6, similarly to the first and second embodiments, though the transmission and reception are intrinsically performed in different wireless apparatus.

The wireless transmission unit 0103 has the function of receiving a transmission beacon period set signal 0702 inputted from an upper layer application which controls the wireless apparatus 0701 and changing a beacon period. The beacon period is changed in accordance with the packet bandwidth of a packet to be transmitted.

The wireless apparatus 0701 is also provided with a changed-beacon-period detection unit 0703 and a parameter set unit 0705. A description will be given herein below to the characteristic operation of the wireless apparatus 0701.

The wireless reception unit 0104 extracts the reception frame body signal 0119 and the reception beacon signal 0118 from the wireless signal 0117 received via the antenna 0102 in the same manner as in the first embodiment. The reception frame body signal 0119 is processed in the same manner as in the first embodiment. By contrast, the reception beacon signal 0118 is outputted not only toward the wireless reference clock generation unit 0303 in the same manner as in the first embodiment but also toward the changed-beacon-period detection unit 0703 in the present embodiment.

The reception beacon signal 0118 has a beacon interval added thereto so that the changed-beacon-period detection unit 0703 to which the reception beacon signal 0118 has been inputted detects the changed beacon period based on the beacon interval.

When the changed beacon period is detected, the changed-beacon-period detection unit 0703 outputs a changed-beacon-period detection signal 0706 and a reception beacon period value 0704.

The reception beacon period value 0704 is inputted to the parameter set unit 0705, in which a PLL set signal 0707 is generated. The PLL set signal 0707 is outputted toward the wireless reference clock generation unit 0303. In the wireless reference clock generation unit 0303, the wireless clock 0111 based on the reception beacon signal 0118, on the changed-beacon-period detection signal 0706, and on the PLL set signal 0707 is generated.

As will also be described later, the PLL set signal 0707 includes a reference-clock-frequency-division-ratio set signal 0801, an order-coefficient set signal 0802, a gain set signal 0803, and a generated-clock-frequency-division-ratio set signal 0804.

With such a structure, even when the beacon period is changed, the wireless clock 0111 according to the present embodiment can be synchronized with the transmitter wireless apparatus by generating the wireless clock synchronized with the wireless clock of the transmitter in response to the change in beacon period in the received wireless signal 0117.

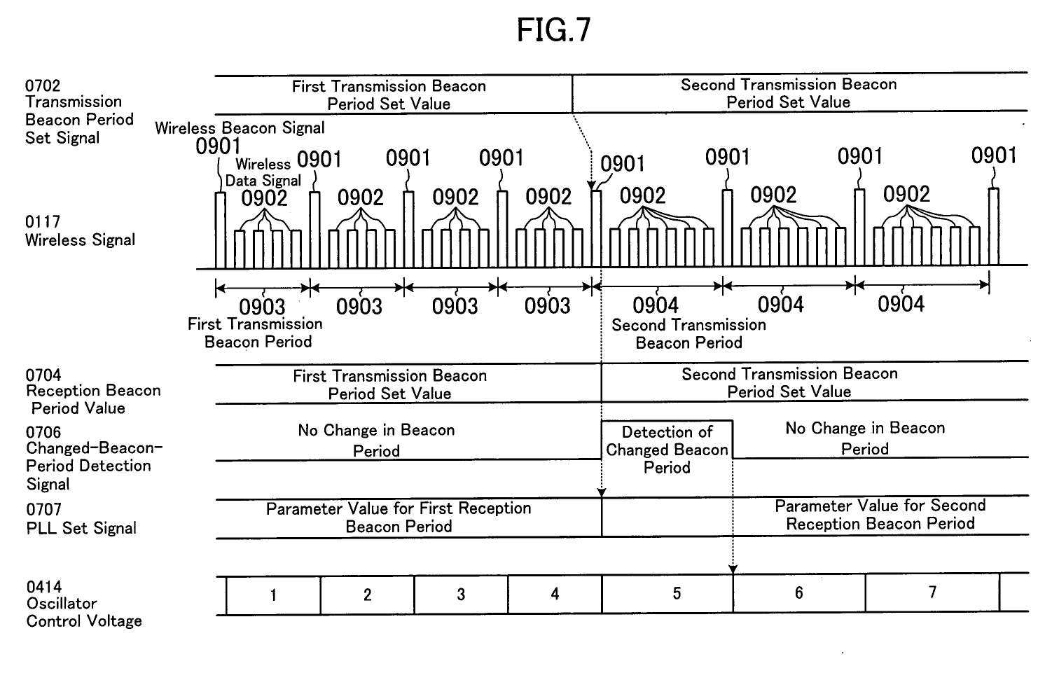

FIG. 7 shows the respective operations of individual signals and the like when the transmission-beacon-period set signal 0702 is changed from a first transmission beacon period set value to a second transmission beacon period set value. The individual signals and the like are the wireless signal 0117, the reception beacon period value 0704, the changed-beacon-period detection signal 0706, the PLL set signal 0707, and the oscillator control voltage 0414 (which will be described later).

In the case where the wireless signal 0117 is transmitted with the first transmission beacon period set value, a wireless beacon signal 0901 is outputted in each first beacon period 0903, while a wireless data signal 0902 is outputted during the time period except for the time period in which the wireless beacon signal 0901 is outputted.

With a change in the amount of transmission data, the transmission-beacon-period set signal 0702 is changed from the first transmission beacon period set value to a second transmission beacon period set value in the transmitter wireless apparatus. As a result, the wireless beacon signal 0901 is outputted in each second transmission beacon period 0904 and the wireless data signal 0902 is outputted during the time period in which the wireless beacon signal 0901 is outputted.

Such a change in beacon period is detected in the changed-beacon-period detection unit 0703 and the changed-beacon-period detection unit 0703 outputs the changed-beacon-period detection signal 0706 as a result of the detection, as described above. Thereafter, the PLL set signal 0707, the oscillator control voltage 0414, and the like are set individually.

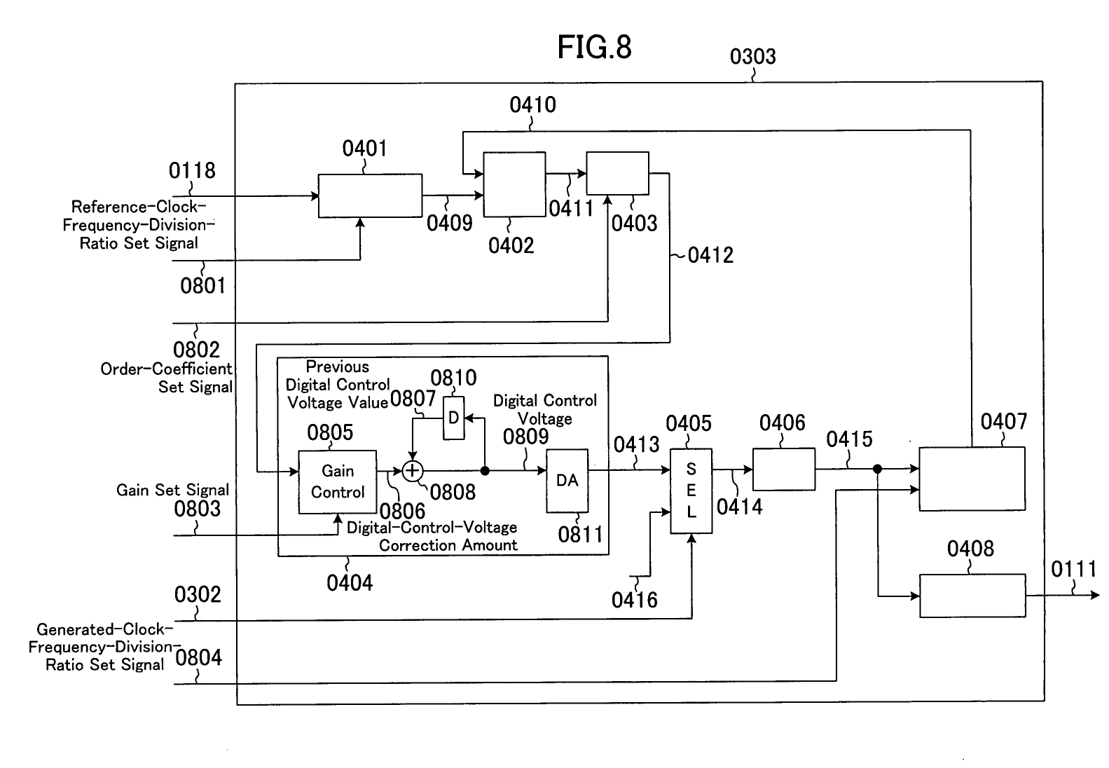

FIG. 8 shows a structure of the wireless reference clock generation unit 0303 used in the wireless apparatus 0701 according to the present embodiment. A detailed description of the components shown in FIG. 8 which are the same as those of the wireless reference clock generation unit according to the first embodiment shown in FIG. 2 will be omitted by retaining the same reference numerals as used in FIG. 2. The description will be given primarily to the differences between the wireless reference clock generation units shown in FIGS. 2 and 8. FIG. 8 also shows the specific structure of the voltage conversion circuit 0404.

To the wireless clock 0111 according to the present embodiment, the reception beacon signal 0118 and the reference voltage switch signal 0302 are inputted in the same manner as in the wireless reference clock generation unit according to the first embodiment.

In addition, the PLL set signal 0707, i.e., the reference-clock-frequency-division-ratio set signal 0801, the order-coefficient set signal 0802, the gain set signal 0803, and the generation-clock-frequency-division-ratio-set-signal 0804 are also inputted.

The reference-clock-frequency-division-ratio set signal 0801 for setting a frequency division ratio for dividing the frequency of the reception beacon signal 0118 is inputted to the reference clock frequency divider 0401. As a result of frequency division in accordance with the reference-clock-frequency-division-ratio-set signal 0801, the reference clock frequency-divided signal 0409 is outputted.

On receiving the reference clock frequency-divided signal 0409 and the generated clock frequency-divided signal 0410, the phase comparator 0402 generates the phase comparison signal 0411 with a digital value and outputs the phase comparison signal 0411 toward the low pass filter 0403.

The low pass filter 0403 receives the order-coefficient set signal 0802 in addition to the phase comparison signal 0411. By the order-coefficient set signal 0802, the characteristics (i.e., order and coefficient) of the low pass filter 0403 as a digital filter are set. In accordance with the set order and coefficient, the low pass filter 0403 outputs the gain signal 0412 toward the voltage conversion circuit 0404.

To the voltage conversion circuit 0404, the gain set signal 0803 in addition to the gain signal 0412 is inputted, thereby setting the gain of the gain signal 0412. The voltage conversion circuit 0404 outputs the gain control voltage 0413 toward the reference voltage switch 0405.

The voltage conversion circuit 0404 comprises: a gain control 0805; an adder 0808; a flip-flop 0810 (D); and a digital/analog converter 0811 (DA) to constitute a digital PLL.

The voltage conversion circuit 0404 converts a digital control voltage 0809 to an analog signal by using the digital/analog converter 0811, thereby generating the gain control voltage 0413. The digital control voltage 0809 is corrected based on the gain signal 0412 and the gain set signal 0803. The correction process will be described herein below.

First, in the gain control 0805, the gain of the gain signal 0412 is variable in accordance with the inputted gain set signal 0803. By amplifying or attenuating the inputted gain signal 0412 in accordance with the gain set signal 0803, a digital-control-voltage correction amount 0806 is outputted.

The adder 0808 adds up the control values for the oscillator 0406. That is, the adder 0808 adds a previous digital control voltage value 0807 held in the flip-flop 0810 to the digital-control-voltage correction amount 0806 and outputs the sum as the digital control voltage 0809.

Thereafter, the digital control voltage 0809 is converted to an analog signal by the digital/analog converter 0811, which is outputted as the gain control voltage 0413 toward the reference voltage switch 0405.

In the flip-flop 0810, the value of the digital control voltage 0809 is held as the previous digital control voltage value 0807 with the timing with which the digital control voltage 0809 is converted to the analog signal.

The reference voltage switch 0405 and the oscillator 0406 are the same as in the first embodiment. The oscillator 0406 outputs the generated clock 0415 toward the generated clock frequency divider 0407 and toward the wireless clock generator 0408.

To the generated clock frequency divider 0407, the generated-clock-frequency-division-ratio set signal 0804 is inputted in addition to the generated clock 0415. The generated clock frequency divider 0407 divides the frequency of the generated clock in accordance with the generated-clock-frequency-division-ratio set signal 0804 and outputs the generated clock frequency-divided signal 0410 toward the phase comparator 0402.

The wireless clock generator 0408 outputs the wireless clock 0111 based on the generated clock 0415.

When the wireless apparatus according to the present embodiment is used to perform wireless communication which allows the beacon period to be set in accordance with the data bandwidth, the structure described above allows programmable generation of the wireless clock 0111 in accordance with the beacon period of the wireless apparatus as the communication partner and allows synchronization with the wireless apparatus as the communication partner. It is also possible to increase accuracy by providing the timer unit 0602 for time stamp, in the same manner as in the second embodiment.

### Embodiment 4

A description will be given next to a wireless apparatus according to the fourth embodiment of the present invention and to the operation thereof with reference to the drawings.

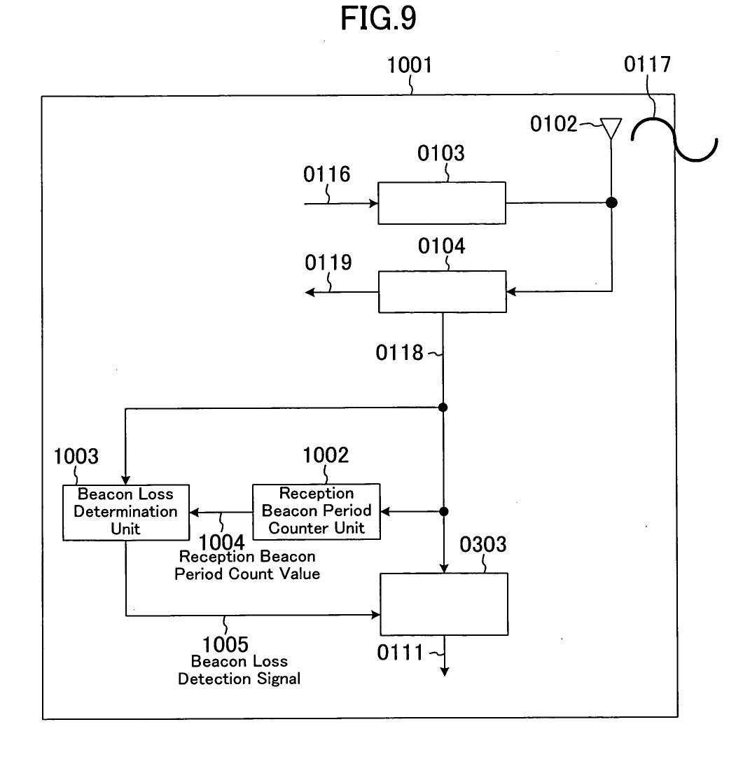

FIG. 9 shows a wireless apparatus 1001 according to the fourth embodiment. The wireless apparatus 1001 has a structure including components common to the wireless apparatus 0301 according to the third embodiment and further including several other components added thereto. Therefore, FIG. 9 primarily shows a portion characteristic of the wireless apparatus 1001 according to the present embodiment, while omitting the depiction of a part thereof. The present embodiment will also describe both transmission and reception by using only the wireless apparatus 1001, similarly to the first embodiment, though wireless communication is intrinsically performed through the reception of a wireless signal, which has been transmitted from the wireless apparatus 1001, by another wireless apparatus (not shown).

The wireless apparatus 1001 is provided with a reception beacon period counter unit 1002 and with a beacon loss determination unit 1003 in addition to the components of the wireless apparatus 0701 according to the third embodiment. A description will be given herein below to the characteristic operation of the wireless apparatus 1001.

The wireless reception unit 0104 extracts the reception frame body signal 0119 and the reception beacon signal 0118 from the wireless signal 0117 received via the antenna 0102 in the same manner as in the third embodiment. The reception frame body signal 0119 is processed in the same manner as in the third embodiment. The reception beacon signal 0118 is outputted toward the wireless reference clock generation unit 0303 in the same manner as in the third embodiment so that the wireless reference clock generation unit 0303 outputs the wireless clock 0111 based on the reception beacon signal 0118.

In the present embodiment, however, the received reception beacon signal 0118 is outputted also to the reception beacon period counter unit 1002 and to the beacon loss determination unit 1003.

The reception beacon period counter unit 1002 outputs a reception beacon period count value 1004 for measuring the reception beacon interval toward the beacon loss determination unit 1003.

The beacon loss determination unit 1003 has the function of outputting a beacon loss detection signal 1005 toward the wireless reference clock generation unit 0303. The beacon loss detection signal 1005 indicates the detection of a beacon loss.

The wireless reference clock generation unit 0303 outputs the wireless clock 0111 in response to the inputting of the beacon loss detection signal 1005.

Such a structure allows the generation of a clock tolerable to the loss of the reception beacon signal 0118, which will be further described herein below.

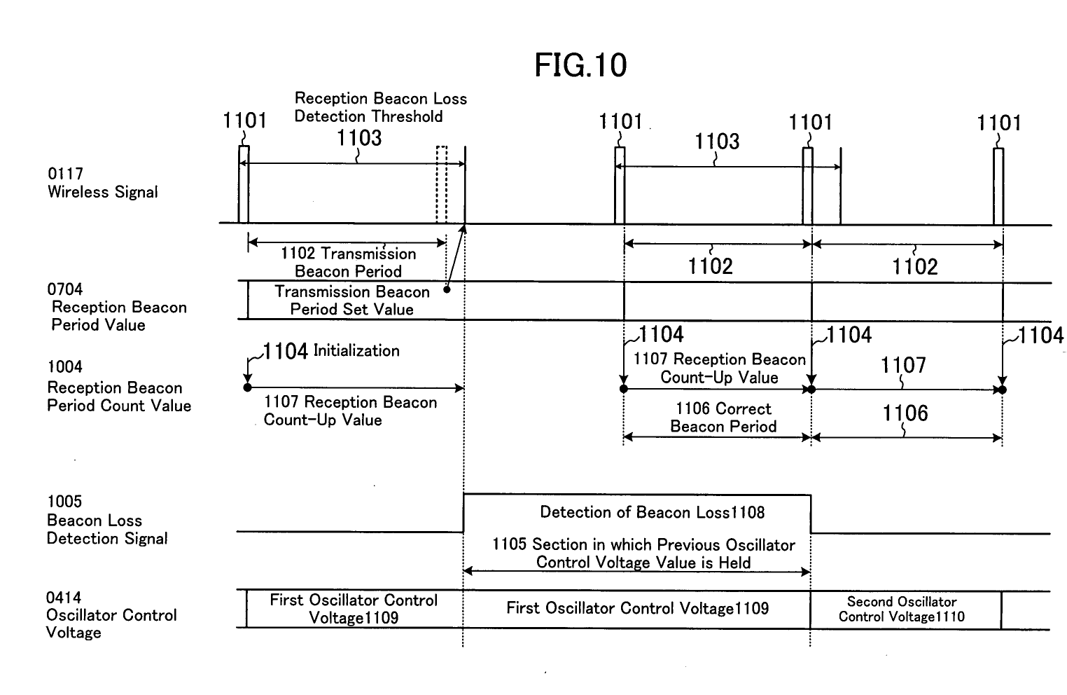

FIG. 10 shows the wireless signal 0117, the reception beacon period value 0704, the reception beacon period count value 1004, the beacon loss detection signal 1005, and the oscillator control voltage 0414 when the loss of the beacon signal has occurred.

The reception beacon period count value 1004 is a count value (Reception Beacon Count-Up Value 1107 in FIG. 10) at which counting is started (Initialization 1104 in FIG. 10) with the reception timing of the wireless beacon signal 1101.

The beacon loss detection signal 1005 indicates the detection of a beacon loss based on the wireless beacon signal 1101 and on the reception beacon period count value 1004. The beacon loss detection signal 1005 is generated as follows.

First, the beacon loss determination unit 1003 interprets the transmission beacon period 1102, which is the interval of the wireless beacon signals 1101, in accordance with the beacon interval included in the reception beacon signal 0118 and generates a reception beacon loss detection threshold 1103. When the next wireless beacon signal 1101 cannot be received within the limits of the reception beacon loss detection threshold 1103 by using the reception beacon period count value 1004 which is initialized on receipt of the wireless beacon signal 1101, the beacon loss detection signal 1005 is outputted on the assumption that the beacon is lost.

When the beacon loss detection signal 1005 is inputted to the wireless reference clock generation unit 0303, the digital-control-voltage correction amount 0806 is set to 0 (zero) in the same voltage conversion circuit 0404 as used in the third embodiment shown in FIG. 8. This allows retention and stable output of the digital control voltage 0809 (First Oscillator Control Voltage in FIG. 10) generated based on the reception beacon signal 0118 before the beacon is lost. As a result, the wireless clock 0111 is also supplied stably.

Next, when the wireless apparatus 1001 receives the wireless beacon signal 1101 with a correct beacon interval during the detection of the beacon loss, i.e., in Section 1105 in which Previous Oscillator Control Voltage Value is Held in FIG. 10, the correction of the digital control voltage 0809 is resumed. That is, the correction of the digital control voltage 0809 based on the digital-control-voltage correction amount 0806 is performed and the corrected digital control voltage 0809 is converted to an analog signal, which is outputted as the gain control voltage 0413. As a result, it becomes possible to resume the synchronization with the output-side wireless apparatus.

With such a structure, the present embodiment can implement a wireless apparatus and a wireless method each of which has reduced packet fluctuations and allows stable reception of the wireless signal to be performed even when the reception beacon signal is lost. In the present embodiment also, accuracy can be increased by providing the timer unit 0602 for time stamp in the same manner as in the second embodiment.

### Embodiment 5

A description will be given next to a wireless apparatus according to the fifth embodiment of the present invention and to the operation thereof with reference to the drawings.

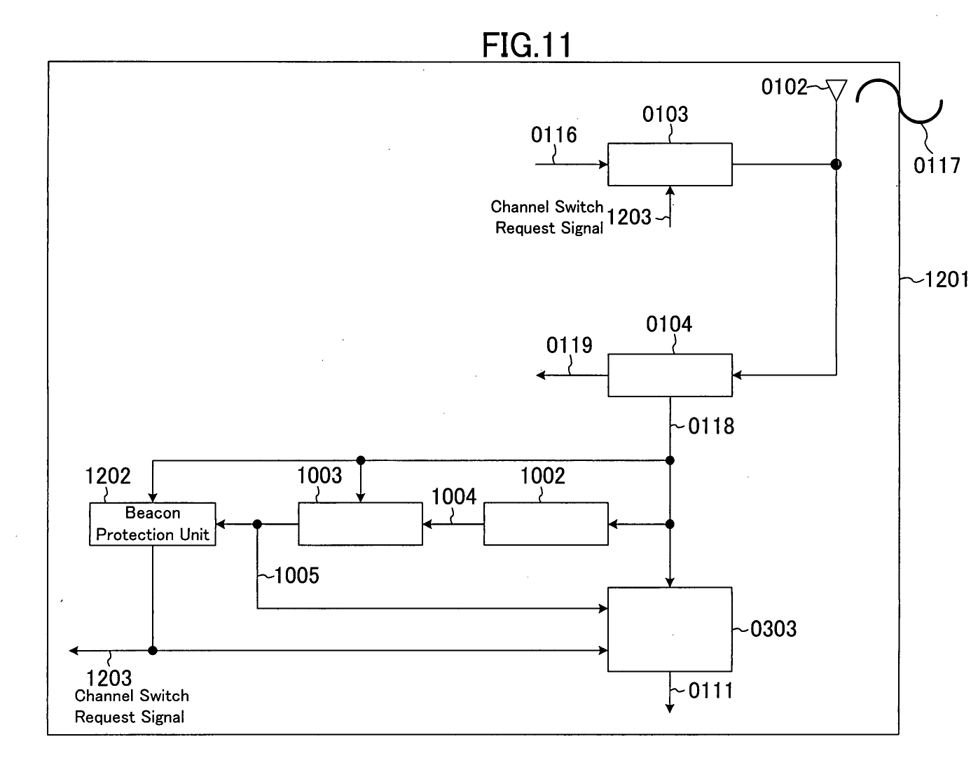

FIG. 11 shows a wireless apparatus 1201 according to the fifth embodiment. The wireless apparatus 1201 has a structure including components common to the wireless apparatus 1001 according to the fourth embodiment and further including several other components added thereto. Therefore, FIG. 11 primarily shows a portion characteristic of the wireless apparatus 1201 according to the present embodiment, while omitting the depiction of a part thereof. The present embodiment will describe both transmission and reception by using only the wireless apparatus 1201 of FIG. 11, similarly to the first embodiment.

The wireless apparatus 1201 of FIG. 11 is provided with a beacon protection unit 1202 in addition to the components of the wireless apparatus 1001 according to the fourth embodiment. The beacon protection unit 1202 outputs a channel switch request signal 1203. A description will be given herein below to the characteristic operation of the wireless apparatus 1201.

In the wireless apparatus 1201 according to the present embodiment, the channel switch request signal 1203, which will be described later, is inputted to the wireless transmission unit 0103. In the same manner as in the wireless apparatus 1001 according to the fourth embodiment, the reception beacon signal counter unit 1002 outputs the reception beacon signal count value 1004 based on the reception beacon signal 0118, while the beacon loss determination unit 1003 outputs the beacon loss detection signal 1005.

In the present embodiment, however, the reception beacon signal 0118 and the beacon loss detection signal 1005 are also inputted to the beacon protection unit 1202. The beacon protection unit 1202 outputs the channel switch request signal 1203 toward the wireless reference clock generation unit 0303 and toward the wireless transmission unit 0103 based on the detection status of the beacon loss detection signal 1005.

With the structure described above, the wireless apparatus 1201 according to the present embodiment is allowed to perform stable clock generation even when channel switching is performed, which will be described herein below.

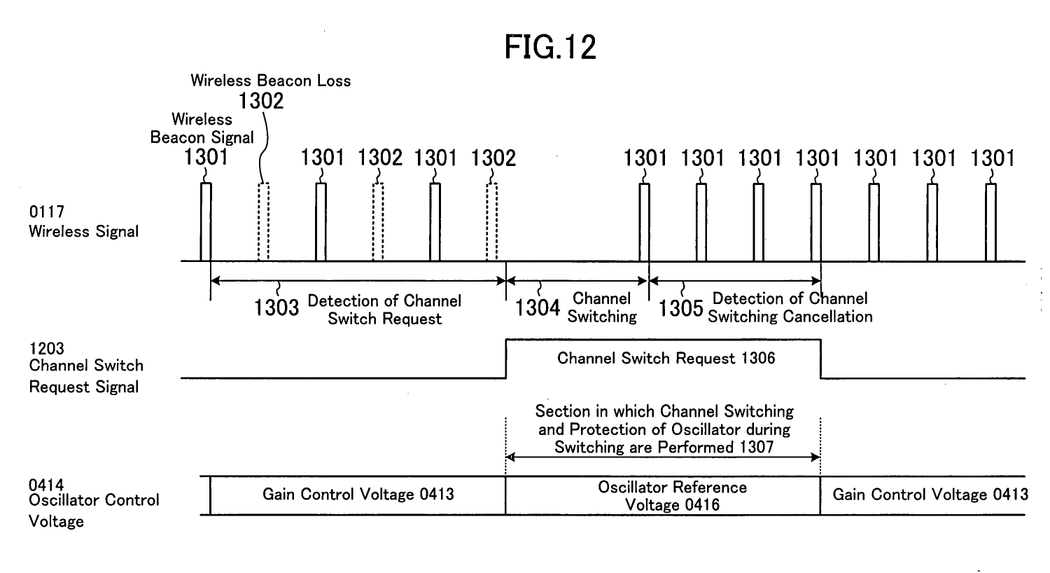

FIG. 12 shows the wireless signal 0117, the channel switch request signal 1203, and the oscillator control voltage 0414 when channel switching is performed.

On detecting that conditions for detection (Detection of Channel Switch Request 1303 in FIG. 12) are satisfied for the wireless beacon signal 1301 included in the wireless signal 0117, the beacon protection unit 1202 outputs the channel switch request signal 1203 (Channel Switch Request 1306 in FIG. 12). The conditions for detection include, e.g., no detection of a beacon within a set time period, consecutive occurrences of the beacon loss 1302 within the set time period, and consecutive occurrences of the status in which the beacon loss 1302 is detected once or more times within the set time period.

On receiving the channel switch request signal 1203, the wireless transmission unit 0103 issues a channel switch request to the wireless apparatus (not shown) which has outputted a beacon signal on a wireless line and performs channel switching between the individual wireless apparatus currently in communication. At this time, when the wireless clock 0111 used in the wireless apparatus 1201 is synchronized with the reception beacon signal 0118, the reception of the reception beacon signal 0118 becomes unstable. Accordingly, it may be assumed that the wireless clock 0111 also becomes unstable.

To prevent this, a clock based on a stable free-running internal clock is used as the wireless clock 0111 when channel switching is performed (in Section 1307 in which Channel Switching and Protection of Oscillator during Switching are Performed). This can be implemented by causing the same wireless reference clock generation unit 0303 as shown in FIG. 8 to output the oscillator control voltage 0414 based on the oscillator reference voltage 0416. For this purpose, the reference voltage switch signal 0302 is controlled such that the oscillator reference voltage 0416 is selected in the reference voltage switch 0405.

The oscillator control voltage 0414 before channel switching is performed is the gain control voltage 0413 generated based on the reception beacon signal 0118. However, when the beacon is lost, the oscillator control voltage 0414 before channel switching may also be the gain control voltage 0413 which has been held from before the beacon loss instead of the gain control voltage 0413 generated based on the reception beacon signal 118, as described in the fourth embodiment.

Next, when the statuses which do not satisfy the conditions for detecting the channel switch request consecutively occur within the set time period after channel switching is performed (within the time period of Detection of Channel Switch Cancellation 1305 of FIG. 12), the channel switch request 1306 is cancelled. That is, the beacon protection unit 1202 cancels the channel switch request using the channel switch request signal 1203.

When the channel switch request signal 1203 is cancelled, the wireless reference clock generation unit 0303 generates the wireless clock 0111 by performing switching from the clock based on the free-running internal clock to the wireless clock synchronized with the transmitter wireless apparatus. For this purpose, the wireless reference clock generation unit 0303 performs switching from the oscillator reference voltage 0416 to the gain control voltage 0413 (see FIG. 8 and the like.).

When the channel switch request signal 1203 is not cancelled even after channel switching is performed (i.e., when the conditions for detecting the channel switch request remain satisfied), switching to another channel is performed and the same process is continued.

In the manner described above, the wireless apparatus 1201 according to the present embodiment can generate a stable wireless clock even when channel switching is performed as a result of the loss of the reception beacon signal 0118. In the present embodiment also, accuracy can be increased by providing the timer unit 0602 for time stamp in the same manner as in the second embodiment.

### Embodiment 6

A description will be given next to a wireless apparatus according to the sixth embodiment of the present invention and to the operation thereof with reference to the drawings.

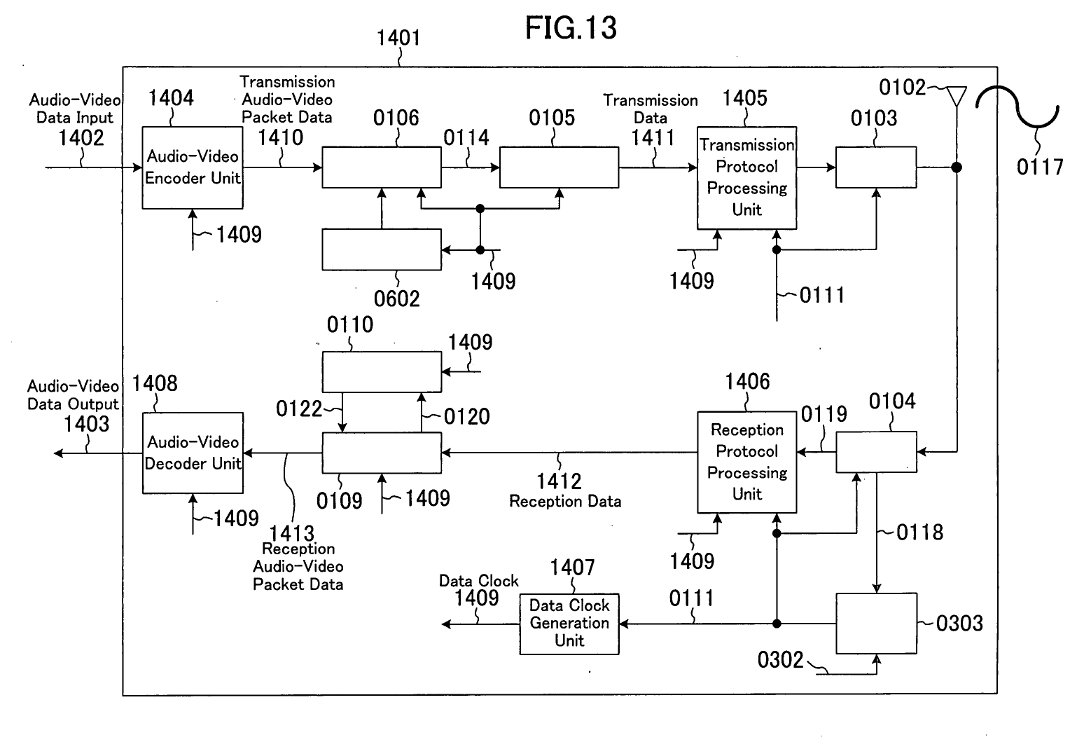

FIG. 13 schematically shows the structure of a wireless apparatus 1401 according to the present embodiment. In addition to the structure of the conventional wireless apparatus comprising a data clock generation unit 1407 for generating an audio-video clock, the wireless apparatus 1401 also has the capability of synchronizing the data clock generation unit 1407 with the wireless clock 0111. FIG. 13 shows that, compared with the wireless apparatus 0601 according to the second embodiment shown in FIG. 5, the wireless apparatus 1401 according to the present embodiment further comprises the data clock generation unit 1407 and also depicts an audio-video encoder unit 1404, a transmission protocol processing unit 1405, a reception protocol processing unit 1406, and an audio-video data decoder unit 1408. The wireless apparatus 1401 may also include the components described in the third, fourth, and fifth embodiments, though they are not depicted.

The description will be given herein below to the wireless apparatus 1401.

First, the operation of the transmitter will be described. On receiving an audio-video data input 1402, the audio-video encoder unit 1404 encodes the audio-video data input 1402 by using a data clock 1409 and outputs the encoded audio-video data input 1402 as transmission audio-video packet data 1410 toward the time stamp add unit 0106.

In contrast to the conventional embodiment in which the data clock of the transmitter has been locked to the transmission beacon signal, the data clock 1409 according to the present embodiment is generated based on the wireless clock 0111.

On receiving the transmission audio-video packet data 1410, the time stamp add unit 0106 adds the transmission time stamp 0603 to the transmission audio-video packet data 1410 in accordance with the input timing of the transmission audio-video packet data 1410 and outputs it as the time-stamp-added packet 0114 toward the frame body assembly unit 0105. At this time, the transmission time stamp 0603 is generated based on the data clock 1409.

On receiving the time-stamp-added packet 0114, the frame body assembly unit 0105 generates transmission data 1411 from the single time-stamp-added packet 0114 or from an assembly of the plurality of time-stamp-added packets 0114 in accordance with a data format for an upper wireless layer (e.g., TCP/IP, UDP/IP, or the like) and outputs the transmission data 1411 toward a transmission protocol processing unit 1405.

On receiving the transmission data 1411, the transmission protocol processing unit 1405 adds a header to the transmission data 1411 in accordance with the protocol and outputs the transmission data 1411 with the header as the transmission frame body signal 0116 toward the wireless transmission unit 0103. On receiving the transmission frame body signal 0116, the wireless transmission unit 0103 outputs it as the wireless signal 0117 via the antenna.

The receiving operation will be described next. The wireless signal 0117 outputted from the wireless apparatus 1401 is received by the other wireless apparatus (not shown). However, the description will be given herein on the assumption that the receiving operation is performed in the wireless apparatus 1401, in the same manner as in the other embodiments.

The wireless reception unit 0104 receives the wireless signal 0117 via the antenna 0102. The wireless reception unit 0104 extracts the reception frame body signal 0119 and the reception beacon signal 0118 from the wireless signal 0117 and outputs them. The wireless reference clock generation unit 0303 receives the reception beacon signal 0118 and outputs the wireless clock 0111 synchronized with the wireless clock of the transmitter wireless apparatus in the same manner as in the first embodiment.

On receiving the reception frame body signal 0119 from the wireless reception unit 0104, the reception protocol processing unit 1406 checks the header in accordance with the upper layer protocol. When an error is not found herein, the reception protocol processing unit 1406 removes the header in accordance with the upper layer protocol and outputs the reception frame body signal 0119 without the header as reception data 1412 toward the frame body disassembly unit 0109.

The frame body disassembly unit 0109 disassembles the reception data 1412, which is either the single time-stamp-added packet 0114 or the assembly of the plurality of time-stamp-added packets 0114, into the individual discrete time-stamp-added packets 0114. The frame body disassembly unit 0109 further outputs each of the time stamps added at the transmitter as the reception time stamp 0120 toward the packet read control unit 0110. Such an operation of the frame body assembly unit 0105 is the same as in the prior art technology. However, the characteristic feature of the present embodiment is that the data clock 1409 of the receiver is generated based on the wireless clock 0111. The wireless clock 0111 is synchronized with the wireless clock of the transmitter.

The packet read control unit 0110 outputs the packet read signal 0122 toward the frame body disassembly unit 0109 based on the difference between the previously inputted reception time stamp 0120 and the newly inputted reception time stamp 0120.

On receiving the packet read signal 0122, the frame body disassembly unit 0109 generates reception audio-video packet data 1413 by removing the reception time stamp 0120 from each of the time-stamp-added packets 0114 and outputs the audio-video packet data 1413 toward the audio-video decoder unit 1408.

The audio-video decoder unit 1408 decodes the transmission audio-video packet data 1410 inputted thereto in accordance with the data clock 1409 and outputs the decoded transmission audio-video packet data 1410 as audio-video packet data 1403.

In this manner, the wireless apparatus 1401 according to the present embodiment can implement real-time high-quality transmission of audio-video data.

As stated previously, the beacon signal does not return a receipt acknowledgment signal (ACK). Accordingly, in a situation in which the beacon signal cannot be received, the conventional wireless apparatus cannot properly reproduce the clock so that the characteristic degradation of the audio-video data occurs.

By contrast, the wireless apparatus 1401 according to the present embodiment synchronizes the data clock for processing the audio-video data with the wireless clock, thereby allowing the suppression of the characteristic degradation of the audio-video data during the reproduction thereof and allowing real-time high-quality transmission and reproduction of audio data. Packet fluctuations are suppressed by synchronizing the respective wireless clocks of the transmitter wireless apparatus and the receiver wireless apparatus with each other in the same manner as in the other embodiments of the present invention.

### Embodiment 7

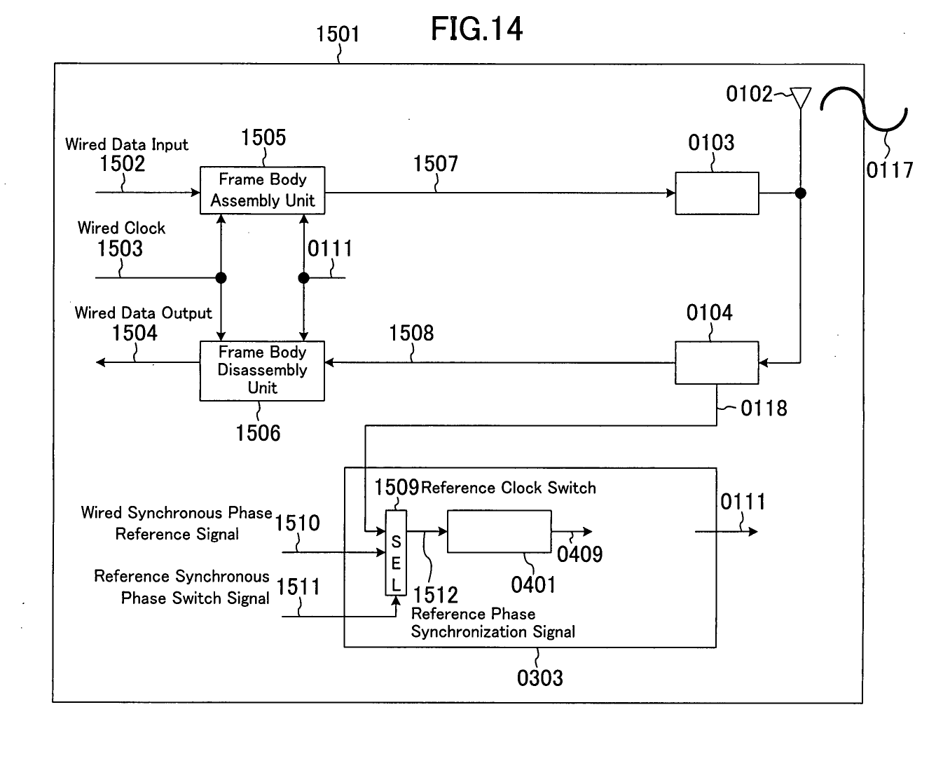

FIG. 14 shows the structure of the characteristic portion of a wireless apparatus 1501 according to the seventh embodiment of the present invention. Compared with the wireless apparatus according to the other embodiments of the present invention, the wireless apparatus 1501 further has a structure for synchronization with a wired network.

Specifically, the wireless reference clock generation unit 0303 provided in the wireless apparatus 1501 comprises a reference clock switch 1509 in addition to the wireless reference clock generation unit shown in, e.g., FIG. 2. To the frame body assembly unit 0105 and to the frame body disassembly unit 0109, a wired clock 1503 is further inputted. A description will be given herein below to the characteristic operation of the wireless apparatus 1501.

In the same manner as in the prior art technology, a wired data input 1502 synchronized with the wired clock 1503 is inputted to the frame body assembly unit 1505. The frame body assembly unit 1505 generates a transmission frame body signal 1507 in accordance with a wireless LAN format and outputs the transmission frame body signal 1507 toward the wireless transmission unit 0103. The wireless transmission unit 0103 adds a header to the transmission frame body signal 1507, modulates the transmission frame body signal 1507 with the header, and outputs the modulate transmission frame body signal 1507 as the wireless signal 0117 via the antenna 0102.

Although the wireless signal 0117 is received by another wireless apparatus not shown, the description will also be given herein by using an operation when the wireless apparatus 1501 performs reception as a substitute, in the same manner as in the other embodiments.

The wireless reception unit 0104 receives the wireless signal 0117 via the antenna 0102 and performs an error check needed in the wireless LAN after demodulation, in the same manner as in the conventional embodiment. If there is no error, the wireless reception unit 0104 outputs the reception frame body signal 1508 toward the frame body disassembly unit 1506. At the same time, the wireless reception unit 0104 outputs the reception beacon signal 0118 toward the wireless reference clock generation unit 0303.

The frame body disassembly unit 1506 disassembles the reception frame body signal 1508 inputted thereto and outputs it.

However, when the wireless apparatus 1501 is used as an access point, the wireless clock 0111 synchronized with a wired synchronous phase reference signal 1510 composed of a wired clock, a wired frame signal, and the like inputted from a wired apparatus is used. To generate the wired clock 0111 which is synchronized with such a wired network, the wireless reference clock generation unit 0303 is provided with the reference clock switch 1509. The reference clock switch 1509 has the function of selecting either one of the reception beacon signal 0118 and the wired synchronous phase reference signal 1510 which is synchronous with the wired network and outputting the selected one as a reference phase synchronization signal 1512 toward the reference clock frequency divider 0401. As for the subsequent operation of the wireless reference clock generation unit 0303, it is the same as in the other embodiments, e.g., in the wireless reference clock generation unit shown in FIG. 2 or 8.

This allows selective use of an arbitrary one of the wireless clock 0111 synchronized with the reception beacon signal 0118 and the wireless clock 0111 composed of a free-running master clock, in the same manner as in the other embodiments. In addition, it is also possible in the present embodiment to selectively use the wireless clock 0111 synchronized with the wired synchronous phase reference signal 1510.

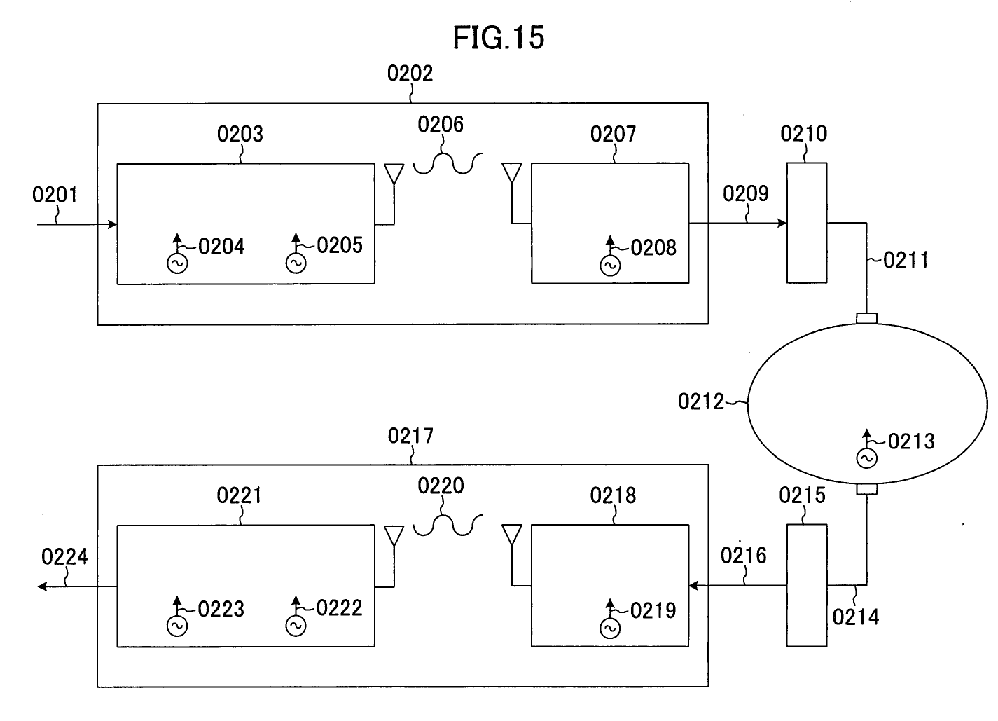

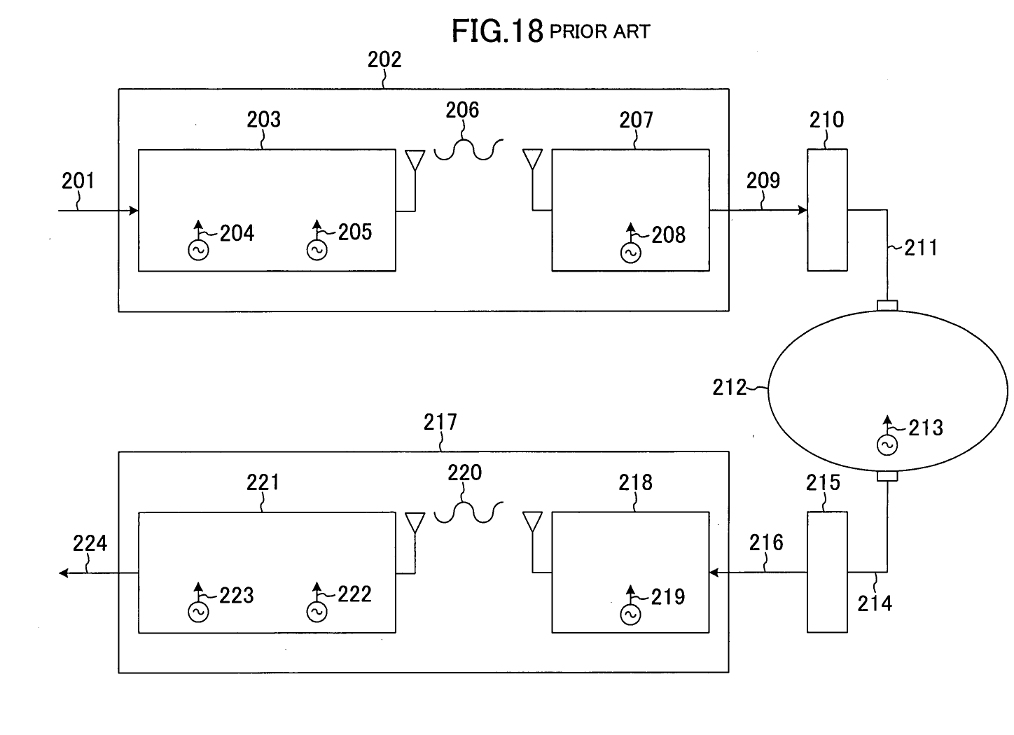

FIG. 15 shows the connection between the wireless LAN using the wireless apparatus 1501 according to the present embodiment and a wired network 0212, which is the same as in the conventional structure shown in FIG. 18. However, the wireless apparatus 1501 is used as each of a wireless apparatus 2 (AP) 0207 and a wireless apparatus 3 (AP) 0218 as access points, while the wireless apparatus 1401 according to the sixth embodiment is used as each of a wireless apparatus 1 (STA) 0203 and a wireless apparatus 4 (STA) 0221 as stations.

In this manner, the network shown in FIG. 15 can operate by using the synchronized clock. Specifically, the wireless apparatus 1 (STA) 0203 and the wireless apparatus 2 (AP) 0207 are synchronized with each other and the wireless apparatus 3 (AP) 0218 and the wireless apparatus 4 (AP) 0221 are synchronized with each other. In addition, the wireless LAN 0202, the wired network 0212, and the wireless LAN 0217 are synchronized with each other. As a result, it becomes possible to suppress packet fluctuations with regard to data transmission in the network shown in FIG. 15.

This allows real-time transmission of audio-video data between the wireless LAN stations each connected to the wired network 0212, while suppressing the characteristic degradation thereof. It will be easily understood that a wireless apparatus having all the components and all the functions described in the first to seventh embodiments can be implemented.

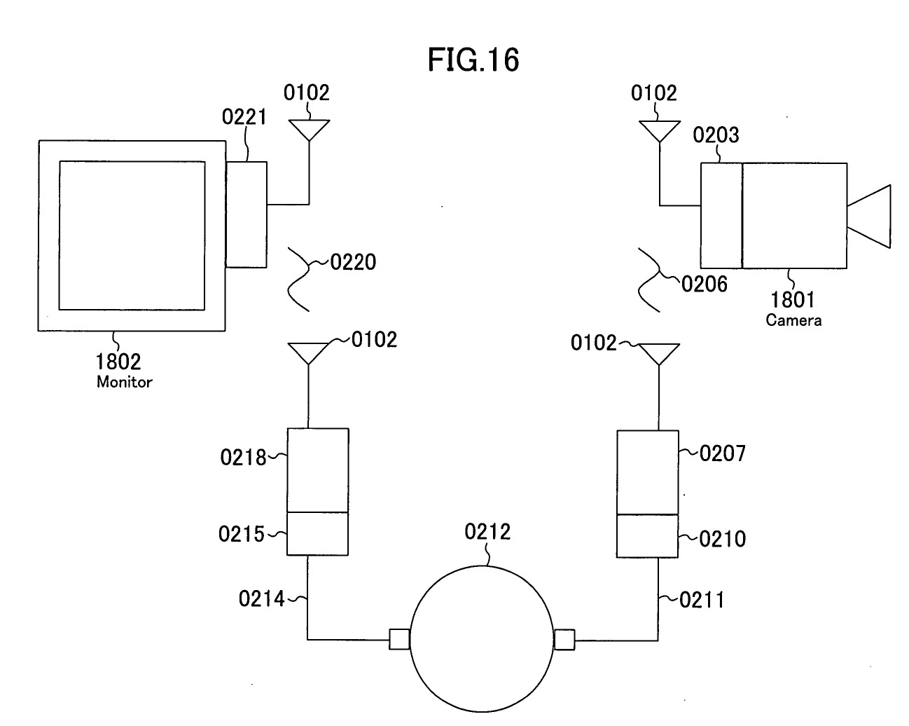

FIG. 16 shows a monitor camera system connected to a wired network to transmit audio-video data by using the wireless apparatus having the structure according to the present embodiment. The monitor camera system generates an audio-video data input 0201 by using a camera 1801 and displays an audio-video data output 0224 by using a monitor apparatus 1802 in the network shown in FIG. 15

In FIG. 16, the camera 1801 which senses a sound, a moving image, or a still image comprises the same wireless apparatus 1 (STA) 0203 as the wireless apparatus according to the first or present embodiment and transmits an audio-video signal resulting from the sensing to the wireless apparatus 2 (AP) 0207 via the wireless apparatus 1 (STA) 0203.

The wireless apparatus 2 (AP) 0207 has at least the function of the wireless apparatus according to the present embodiment. On receiving the audio-video data via the wireless signal 0206, the wireless apparatus 2 (AP) 0207 transmits the audio-video data to a wired apparatus 0215 on the wired network 0212. The wired apparatus 0215 further transmits the audio-video data to the wireless apparatus 3 (AP) 0218 connected thereto.

The wireless apparatus 3 (AP) 0218 transmits the audio-video data received via the wired apparatus 0215 by using a wireless signal 0220. The transmitted wireless signal 0220 is received by the wireless apparatus 4 (STA) 0221 having at least the function of the wireless apparatus according to the first embodiment so that the audio-video data is decoded and displayed on the monitor 1802 comprising the wireless apparatus 4 (STA) 0221. If an audio-video recording apparatus (not shown) is provided in addition to the monitor apparatus 1802, the audio-video data can be recorded on a recording medium such as DVD (Digital Versatile Disc) or hard disc.

The wireless apparatus used in the monitor camera system described above implements real-time high-definition transmission of the audio-video data so that the monitor camera system is useful as a monitor camera system for monitoring a remote location which requires security.

By replacing the camera 1801 with an audio-video reproduction apparatus for reproducing audio-video data from a DVD or the like, it becomes possible to provide an audio-video listening and viewing system which allows real-time high-definition listening and viewing of the audio-video data even when the transmission of audio-video data is performed by wireless communication between the audio-video reproduction apparatus and the monitor apparatus.

There are cases where audio-video data can be transmitted directly between the camera 1801 and the monitor 1802 without intervention of the wired network 0212 by wireless communication. Specifically, there are cases where the audio-video data obtained by using the camera 1801 can be transmitted from the wireless apparatus 1 (STA) 0203 to the wireless apparatus 4 (STA) 0221. In such a case also, real-time high-definition transmission of the audio-video data can be performed by using the wireless apparatus according to any of the embodiments of the present invention.

As described above, the wireless apparatus according to the present invention can perform transmission with reduced packet fluctuations by synchronizing the wireless clock thereof with that of a communication partner with which it performs wireless communication. Therefore, the wireless apparatus is useful as a wireless apparatus which performs real-time high-quality transmission of audio data, video data, or the like.

What is claimed is:

1. A wireless apparatus comprising:
a wireless reception unit for receiving a wireless signal including a frame body signal having a packet with a time stamp added thereto and a beacon signal, extracting the frame body signal and the beacon signal from the wireless signal;
a frame body disassembly unit for extracting the time stamp and the packet from the extracted frame body signal and outputting the extracted time stamp and the extracted packet;
a packet read control unit for generating a packet read signal inputted to the frame body disassembly unit to control the outputting of the packet based on the extracted time stamp and outputting the packet read signal; and
a wireless reference clock generation unit for generating a wireless clock and outputting the wireless clock to the wireless reception unit, the frame body disassembly unit, and to the packet read control unit, wherein
the wireless reference clock generation unit selects either one of a free-running master clock and a clock which is synchronized with the beacon signal by using a PLL and outputs the selected one as the wireless clock.

2. The wireless apparatus of claim 1, further comprising:
a time stamp add unit for adding a transmission time stamp to a packet input in accordance with a transmission beacon signal and outputs the packet input as a time-stamp-added packet;
a frame body assembly unit for generating a transmission frame body signal including the at least one time-stamp-added packet outputted from the time stamp add unit and outputting the transmission frame body signal; and
a wireless transmission unit for generating the transmission beacon signal, outputting the transmission beacon signal to the time stamp add unit, and wirelessly transmitting the transmission beacon signal and the transmission frame body signal.

3. The wireless apparatus of claim 1, further comprising:
a time stamp add unit which comprises a timer unit for a time stamp, adds a transmission time stamp to a packet input based on the timer unit for a time stamp, and outputs the packet input as a time-stamp-added packet;
a frame body assembly unit for generating a transmission frame body signal including the at least one time-stamp-added packet outputted from the timer stamp add unit; and
a wireless transmission unit for generating a transmission beacon signal and wirelessly transmitting the transmission beacon signal and the transmission frame body signal.

4. The wireless apparatus of claim 1, further comprising:
means for detecting a change in a beacon period based on a beacon interval included in the beacon signal; and
means for setting a parameter for the PLL in the wireless reference clock generation unit in response to the change in the beacon period, wherein
the wireless reference clock generation unit generates the wireless clock in accordance with the parameter.

5. The wireless apparatus of claim 3, further comprising:
means for changing a beacon period in accordance with a packet bandwidth;
means for reporting the beacon period by using a beacon interval;
means for detecting a change in the beacon period based on the beacon interval included in the beacon signal; and
means for setting a parameter for the PLL in the wireless reference clock generation unit in response to the change in the beacon period, wherein
the wireless reference clock generation unit generates the wireless clock in accordance with the parameter.

6. The wireless apparatus of claim 4, further comprising:
means for counting the beacon period based on the beacon signal; and
means for detecting a beacon loss based on the beacon interval included in the beacon signal and on a count of the beacon period, wherein
the wireless reference clock generation unit continues to output the same wireless clock as outputted before the detection of the beacon loss when the beacon loss is detected.

7. The wireless apparatus of claim 6, further comprising:
means for requesting switching of a wireless channel based on the beacon signal and on the detection of the beacon loss, wherein
the means for detecting the beacon loss detects cancellation of the beacon loss after the switching of the wireless channel and
the wireless reference clock generation unit outputs the master clock as the wireless clock when the wireless channel is switched and outputs the clock which is synchronized with the beacon signal as the wireless clock after the beacon loss is cancelled.

8. The wireless apparatus of claim 1, further comprising:
means for generating a data clock for processing an audio-video signal formed into the packet, wherein
the data clock is synchronized with the wireless clock.

9. The wireless apparatus of claim 1, further comprising:
means for generating a wireless clock which is synchronized with a wired network based on a wired synchronous phase reference signal in the wired network.

10. A monitor camera system comprising:
a camera for acquiring audio-video data;
a monitor apparatus for displaying the audio-video data; and
a wireless apparatus for transmitting the audio-video data from the camera to the monitor apparatus, wherein
the wireless apparatus is the wireless apparatus of claim 1.

11. An audio-video listening and viewing system comprising:
a reproduction apparatus for reproducing audio-video data;
a monitor apparatus for displaying the audio-video data; and
a wireless apparatus for transmitting the audio-video data from the reproduction apparatus to the monitor apparatus, wherein
the wireless apparatus is the wireless apparatus of claim 1.
